(19) United States
(12) Patent Application Publication
(10) Pub. No.: US 2023/0088208 A1
(43) Pub. Date: Mar. 23, 2023

(54) ELECTRONIC DEVICE, METHOD THEREIN AND COMPUTER-READABLE STORAGE MEDIUM

(71) Applicant: Sony Group Corporation, Tokyo (JP)

(72) Inventors: Chen SUN, Beijing (CN); Yizhi BAI, Beijing (CN)

(73) Assignee: Sony Group Corporation, Tokyo (JP)

(21) Appl. No.: 17/908,914

(22) PCT Filed: Mar. 18, 2021
(86) PCT No.: PCT/CN2021/081470

§ 371 Date: Sep. 2, 2022

(30) Foreign Application Priority Data
Mar. 25, 2020 (CN) 202010217755.2

(51) Int. Cl. H04W 72/04; H04W 72/08

(52) U.S. Cl. CPC H04W 72/0493; H04W 72/082

(57) ABSTRACT

Provided are an electronic device, a method therein and a computer-readable storage medium. The electronic device comprises a processing circuit configured to: receive spectrum usage statistical information from at least one spectrum management sub-device, the spectrum usage statistical information comprising spectrum usage related information and interference related information of a subsystem managed by the spectrum management sub-device; and generate, on the basis of the spectrum usage statistical information from the at least one spectrum management sub-device in an off-line state, spectrum usage guidance information of the subsystem managed by each spectrum management sub-device. Even when part of spectrum management devices cannot communicate with other spectrum management devices in real time, spectrum usage statistical information can still be obtained; and on this basis, guidance information is given for the spectrum usage of sub-systems so as to coordinate the spectrum usage of the sub-systems.

The present application claims priority to Chinese Patent Application No. 202010217755.2, titled “ELECTRONIC DEVICE, METHOD THEREIN AND COMPUTER-READABLE STORAGE MEDIUM”, filed on Mar. 25, 2020 with the China National Intellectual Property Administration, which is incorporated herein by reference in its entirety.

### FIELD

The present disclosure relates to the technical field of wireless communications, and in particular to an electronic device capable of giving guidance on spectrum resource usage, a method in the electronic device, and a computer-readable storage medium.

### BACKGROUND

With the development of wireless communication systems, users have increasingly high service demands for high-quality, high-speed, and new services. Wireless communication operators and device manufacturers have to continuously improve the system to meet the demands of users. This requires a large amount of spectrum resources (which may be quantified as parameters such as time, frequency, bandwidth, maximum allowable transmit power) to support new services and meet high-speed communication demands. Limited spectrum resources have been allocated to fixed operators and services, and newly available spectrum is scarce or expensive. In this case, the concept of dynamic spectrum utilization is proposed, that is, the spectrum resources that have been allocated to some services but are not fully utilized are dynamically utilized. For example, the frequency spectrum of some channels that do not broadcast programs or the frequency spectrum of adjacent channels on the digital television broadcast spectrum is dynamically utilized to perform wireless mobile communication without interfering with the reception of a television signal.

In this application example, since the television broadcast spectrum is allocated for utilization by the television broadcast system, the television broadcast system is called a primary system, and the television set is called a primary user. A mobile communication system that utilizes the television broadcast spectrum without interfering with reception of the television signal is referred to as a secondary system, and a receiver in the mobile communication system is referred to as a secondary user. Here, the primary system may refer to a system having access to a spectrum, for example, the television broadcast system. The secondary system is a system that has no access to the spectrum and only properly utilizes the spectrum when the primary system does not utilize the spectrum, for example, a mobile communication system. In addition, the primary system and the secondary system may both have access to the spectrum, and have different priorities. The primary system may have a higher priority for spectrum usage than the secondary system. For example, when an operator deploys a new base station to provide a new service, the existing base station and the service it provides have priority in spectrum usage. In this case, the existing base station is regarded as the primary system, and the new base station is regarded as the secondary system. The primary system includes a primary base station and a primary user. The secondary system includes a secondary base station and a secondary user.

The secondary systems access the spectrum under the management of a spectrum management device to ensure that the secondary systems do not interfere with the primary system and do not interfere with each other. However, when multiple spectrum management devices operate independently, for example, when some spectrum management devices are deployed on a local computer and do not communicate with other spectrum management device in real time, such spectrum management device only includes spectrum usage related information of the secondary system it manages. Spectrum usage by secondary systems managed by different spectrum management devices cannot be coordinated, resulting in conflict or interference.

### SUMMARY

A brief summary of the present disclosure is described above in order to provide a basic understanding of certain aspects of the present disclosure. It should be understood, however, that this summary is not an exhaustive overview of the present disclosure. This summary is neither intended to identify critical or essential parts of the present disclosure nor to limit the scope of the present disclosure. The only purpose of this summary is to present some concepts related to the present disclosure in a simplified form as a prelude to the more detailed description that is presented later.

In view of the above problems, an object of at least one aspect of the present disclosure is to provide an electronic device, a method in the electronic device, and a computer-readable storage medium. Therefore, even in a case that some spectrum management devices do not communicate with other spectrum management devices in real time, the spectrum usage statistical information of secondary systems managed by the spectrum management devices can be obtained respectively from the spectrum management devices. Guidance is given to the spectrum usage of the secondary systems based on this information to coordinate the spectrum usage of the secondary systems.

According to an aspect of the present disclosure, there is provided an electronic device including processing circuitry configured to: receive spectrum usage statistical information from at least one sub-spectrum management device, the spectrum usage statistical information including: spectrum usage related information of a secondary system managed by the sub-spectrum management device, and interference related information of the secondary system managed by the sub-spectrum management device; and generate, based on the spectrum usage statistical information from the at least one sub-spectrum management device, spectrum usage guidance information for a secondary system managed by each sub-spectrum management device, where the at least one sub-spectrum management device is in an offline state.

According to another aspect of the present disclosure, there is provided an electronic device including processing circuitry configured to: acquire spectrum usage statistical information, the spectrum usage statistical information including: spectrum usage related information of a secondary system managed by said electronic device, and interference related information of the secondary system managed by said electronic device; send the acquired spectrum usage statistical information to a central spectrum device for the central spectrum device to generate, based on spectrum usage statistical information from at least one of the electronic devices in an offline state, spectrum usage guidance information for a secondary system managed by each said electronic device.

According to another aspect of the present disclosure, there is provided an electronic device including processing circuitry configured to: acquire spectrum usage related information of a secondary system where the electronic device is located; send the acquired spectrum usage related information to a sub-spectrum management device that manages the secondary system, for the sub-spectrum management device to send the spectrum usage related information and interference related information of the secondary system to a central spectrum device as spectrum usage statistical information, so that the central spectrum device generates, based on the spectrum usage statistical information from the at least one sub-spectrum management device, spectrum usage guidance information for a secondary system managed by each sub-spectrum management device, where the at least one sub-spectrum management device is in an offline state.

According to another aspect of the present disclosure, there is provided an electronic device including processing circuitry configured to: acquire spectrum usage statistical information of a secondary system managed by the electronic device, where the spectrum usage statistical information includes spectrum usage related information of the secondary system managed by the electronic device and interference related information of the secondary system managed by the electronic device; receive spectrum usage statistical information from other said electronic devices, where at least one of said other electronic devices is in an offline state; and generate, based on the acquired spectrum usage statistical information and the received spectrum usage statistical information, spectrum usage guidance information for the secondary system managed by the electronic device.

According to another aspect of the present disclosure, there is provided an electronic device including processing circuitry configured to: acquire spectrum usage related information of the secondary system in which the electronic device is located; and send the acquired spectrum usage related information to a spectrum management device managing the secondary system, for the spectrum management device to generate spectrum usage guidance information for the secondary system based on spectrum usage statistical information including the spectrum usage related information and interference related information of the secondary system as well as spectrum usage statistical information from other spectrum management devices, where the at least one of the other spectrum management devices is in an offline state.

According to another aspect of the present disclosure, a method in an electronic device is also provided. The method includes: receiving spectrum usage statistical information from at least one sub-spectrum management device, the spectrum usage statistical information including: spectrum usage related information of a secondary system managed by the sub-spectrum management device, and interference related information of the secondary system managed by the sub-spectrum management device; and generating, based on the spectrum usage statistical information from the at least one sub-spectrum management device, spectrum usage guidance information for a secondary system managed by each sub-spectrum management device, where the at least one sub-spectrum management device is in an offline state.

According to another aspect of the present disclosure, a method in an electronic device is also provided. The method includes: acquiring spectrum usage statistical information, the spectrum usage statistical information including: spectrum usage related information of a secondary system managed by said electronic device and interference related information of the secondary system managed by said electronic device; sending the acquired spectrum usage statistical information to a central spectrum device for the central spectrum device to generate, based on spectrum usage statistical information from at least one of the electronic devices in an offline state, spectrum usage guidance information for a secondary system managed by each said electronic device.

According to another aspect of the present disclosure, a method in an electronic device is also provided. The method includes: acquiring spectrum usage statistical information of a secondary system managed by the electronic device, where the spectrum usage statistical information includes spectrum usage related information of a secondary system managed by the electronic device and interference related information of the secondary system managed by the electronic device; receiving spectrum usage statistical information from other said electronic devices, where at least one of said other electronic devices is in an offline state; and generating, based on the acquired spectrum usage statistical information and the received spectrum usage statistical information, spectrum usage guidance information for the secondary system managed by the electronic device.

According to another aspect of the present disclosure, there is also provided a non-transitory computer-readable storage medium having executable instructions stored thereon. The executable instructions, when executed by a processor, cause the processor to perform various functions of the above-described electronic device or method in the electronic device.

According to other aspects of the present disclosure, there are also provided computer program codes and computer program products for implementing the methods according to the present disclosure.

According to at least one aspect of the embodiments of the present disclosure, even in a case that some spectrum management devices cannot communicate with other spectrum management devices in real time, the spectrum usage statistical information of secondary systems managed by the spectrum management devices can be obtained respectively from the spectrum management devices. Guidance is given to the spectrum usage of the secondary systems based on this information to coordinate the spectrum usage of the secondary systems.

Additional aspects of embodiments of the present disclosure are set forth in the description below. The detailed description is to fully disclose the preferred embodiments of the embodiments of the present disclosure without imposing limitations thereon.

### BRIEF DESCRIPTION OF THE DRAWINGS

The drawings described herein are for illustrating selected embodiments only rather than all possible implementations, and are not intended to limit the scope of the present disclosure. In the drawings:

FIG. 1 is a block diagram illustrating a configuration example of an electronic device on a side of a central spectrum device according to an embodiment of the present disclosure;

FIG. 2 is a block diagram illustrating a configuration example of a generation unit in an electronic device on a side of a central spectrum device according to an embodiment of the present disclosure;

FIG. 3 is a block diagram illustrating a first configuration example of an electronic device on a side of a sub-spectrum management device according to an embodiment of the present disclosure;

FIG. 4 is a block diagram illustrating a second configuration example of an electronic device on a side of a sub-spectrum management device according to an embodiment of the present disclosure;

FIG. 5 is a schematic diagram illustrating an example of an information exchange process of centralized spectrum management according to an embodiment of the present disclosure;

FIG. 6 is a schematic diagram illustrating an example application scenario of the centralized spectrum management according to an embodiment of the present disclosure;

FIG. 7 is a block diagram illustrating a first configuration example of an electronic device that may be utilized for distributed spectrum management according to an embodiment of the present disclosure;

FIG. 8 is a block diagram illustrating a second configuration example of an electronic device that may be utilized for distributed spectrum management according to an embodiment of the present disclosure;

FIG. 9 is a schematic diagram illustrating an example of an information exchange process of the distributed spectrum management according to an embodiment of the present disclosure;

FIG. 10 is a flowchart illustrating a process example of a method in an electronic device on a side of a central spectrum device according to an embodiment of the present disclosure;

FIG. 11 is a flowchart illustrating a process example of a method in an electronic device on a side of a sub-spectrum management device according to an embodiment of the present disclosure;

FIG. 12 is a flowchart illustrating a process example of a method that may be utilized in an electronic device for distributed spectrum management according to an embodiment of the present disclosure;

FIG. 13 is a block diagram illustrating an example of a schematic configuration of a server to which the technology of the present disclosure may be applied;

FIG. 14 is a block diagram illustrating a first example of a schematic configuration of an eNB to which the technology of the present disclosure may be applied;

FIG. 15 is a block diagram illustrating a second example of a schematic configuration of an eNB to which the technology of the present disclosure may be applied; and

FIG. 16 is a block diagram of an exemplary structure of a general-purpose personal computer in which methods and/or devices and/or systems according to embodiments of the present invention may be implemented.

Although the present disclosure is susceptible to various modifications and alternative forms, specific embodiments thereof have been shown by way of examples in the drawings and are described in detail herein. It should be understood, however, that the description of specific embodiments herein is not intended to limit the present disclosure to the precise forms disclosed. Instead, the purpose of the present disclosure is to cover all modifications, equivalents and substitutions falling within the spirit and scope of the present disclosure. It should be noted that throughout the drawings, corresponding reference numerals indicate corresponding parts.

### DETAILED DESCRIPTION

Examples of the present disclosure are to be described more fully with reference to the drawings. The following description is merely illustrative in nature and is not intended to limit the disclosure, application, or usages.

Example embodiments are provided so that the present disclosure becomes thorough, and the scope can be fully conveyed to those skilled in the art. Numerous specific details such as examples of specific components, devices, and methods are set forth in order to provide a thorough understanding of embodiments of the present disclosure. It is apparent to those skilled in the art that example embodiments may be embodied in many different forms without the specific details, and that neither should be construed to limit the scope of the present disclosure. In some example embodiments, well-known processes, well-known structures and well-known technologies are not described in detail.

Description is made in the following order:
1. Description of problems;
2. Configuration example of an electronic device for centralized spectrum management
   2.1 Configuration example of an electronic device on a side of a central spectrum device
      2.1.1 One configuration example of an electronic device on a side of a central spectrum device
      2.1.2 Configuration example of a generation unit of an electronic device on a side of a central spectrum device
   2.2 Configuration example of an electronic device on a side of a sub-spectrum management device side
      2.2.1 First configuration example of the electronic device on the side of the sub-spectrum management device
      2.2.2 Second configuration example of the electronic device on the side of the sub-spectrum management device
   2.3 Example of information exchange process for centralized spectrum management
   2.4 Example application scenario for centralized spectrum management mode
3. Configuration example of an electronic device involved in distributed spectrum management
   3.1 First configuration example of an electronic device that may be utilized for distributed spectrum management
   3.2 Second configuration example of an electronic device that may be utilized for distributed spectrum management
   3.3 Example of information exchange process for distributed spectrum management
4. Example of an electronic device on a side of a base station in a secondary system
5. Method Embodiments
   5.1 Method embodiments on a side of a central spectrum device
   5.2 Method embodiments on a side of a sub-spectrum management device
   5.3 Method embodiments in a distributed spectrum management mode
6. Application Examples

### 1. Description of the Problem

The secondary system utilizes an idle spectrum of a primary system under the management of a spectrum management device to ensure that the secondary system does not interfere with the primary system and does not interfere with each other. In a case that multiple spectrum management devices perform spectrum management on different secondary systems and these spectrum management devices operate as sub-spectrum management devices in the a centralized spectrum management mode, a central spectrum device is expected to acquire registration information, spectrum usage related information and primary system information of all secondary systems of these (sub) spectrum management devices in real time, in order to perform calculation based on this information for each spectrum management device to control the managed secondary systems based on the calculation result. In addition, if multiple spectrum management devices perform distributed spectrum management, it is expected that the above information may be exchanged between these spectrum management devices in real time, so that each spectrum management device can perform calculation according to the same algorithm based on the information and control the managed secondary systems according to the calculation result.

However, in practice, there are the following application scenarios: some spectrum management devices are pre-installed with the information of the geographic location database and deployed locally (for example, a local server or a local computer), only communicate with a central spectrum device/other distributed spectrum management devices deployed on a cloud platform at a specific time (for example, at the update timing determined by the update cycle, or when the network is accessible), and are in an offline state where it is impossible to communicate with the central spectrum device/other distributed spectrum management devices in real time (hereinafter, this state is also referred to as “offline state” for short when appropriate) in other time than the specific time. Such a spectrum management device has only spectrum usage related information of the secondary systems it manages in an offline state, resulting in uncoordinated spectrum usage among secondary systems managed by different spectrum management devices, thereby interfering with each other.

Therefore, for the case where some spectrum management devices do no communicate with other spectrum management devices in real time, it is desirable to acquire spectrum usage related information of the secondary systems managed by each spectrum management device in an appropriate manner, and coordinate the spectrum usage of the secondary systems based on such information.

In view of such a case, an electronic device capable of realizing a spectrum management function, a method in the electronic device, an electronic device on the base station side in the secondary system, and a computer-readable storage medium are provided according to the present disclosure. Therefore, even in a case that some spectrum management devices do not communicate with other spectrum management devices in real time, the spectrum usage statistical information of secondary systems managed by the spectrum management devices can be obtained respectively from the spectrum management devices. Guidance is given to the spectrum usage of the secondary systems based on this information to coordinate the spectrum usage of the secondary systems.

The electronic device capable of implementing the functions of the spectrum management device according to the present disclosure may be implemented as any type of server, such as a tower server, a rack server, and a blade server. The electronic device may be a control module (such as integrated circuitry module including a single die, and a card or blade that is inserted into a slot in a blade server) mounted on a server. In addition, at least part of the functions of the electronic device may be realized by a personal computer or the like preinstalled with a program.

The electronic device on the base station side in the secondary system according to the present disclosure may be implemented as any type of TRP (Transmit and Receive Port). The TRP may have sending and receiving functions, for example, may receive information from user equipment and a base station device, and may also send information to the user equipment and base station device. In an example, the TRP may serve the user equipment and be controlled by the base station device. Further, the TRP may have a structure similar to the following base station device, or may only have the structure related to sending and receiving information in the base station device.

In addition, the electronic device on the base station side in the secondary system may also be implemented as any type of base station device, for example, an eNB (evolved node B) or a gNB. In some specific embodiments or examples below, the base station device may be directly described as an example of the electronic device on the base station side of the secondary system. However, the present disclosure is not limited to this, but may be appropriately applied to the case of an electronic device implemented with TRP.

### 2. Configuration Example of an Electronic Device Involved in Centralized Spectrum Management

### 2.1 Configuration Example of an Electronic Device on a Side of a Central Spectrum Device

### 2.1.1 One Configuration Example of an Electronic Device on a Side of a Central Spectrum Device

FIG. 1 is a block diagram illustrating a configuration example of an electronic device on a side of a central spectrum device according to an embodiment of the present disclosure.

As shown in FIG. 1, the electronic device 100 may include a communication unit 110 and a generation unit 120.

Here, each unit of the electronic device 100 may be included in processing circuitry. It should be noted that the electronic device 100 may include either one processing circuitry or multiple processing circuitry. Further, the processing circuitry may include various discrete functional units to perform various different functions and/or operations. It should be noted that these functional units may be physical entities or logical entities, and units with different names may be implemented by the same physical entity.

According to an embodiment of the present disclosure, the communication unit 110 may receive spectrum usage statistical information from at least one sub-spectrum management device. The spectrum usage statistical information includes: spectrum usage related information of a secondary system managed by the sub-spectrum management device and interference related information of the secondary system managed by the sub-spectrum management device. The generation unit 120 may generate spectrum usage guidance information for the secondary system managed by each sub-spectrum management device based on the spectrum usage statistical information respectively from the at least one sub-spectrum management device. The at least one sub-spectrum management device is in an offline state. For example, the offline state here may indicate a state of not communicating with the electronic device 100 in real time.

The spectrum usage statistical information received by the communication unit 110 from the at least one sub-spectrum management device may not be acquired by the sub-spectrum management device in real time. For example, the sub-spectrum management device may be pre-installed with the information of the geographic location database and deployed locally (such as a local server or local computer), and may acquire the spectrum usage statistical information of the managed secondary system in an offline state, but fails to send the spectrum usage statistical information in real time to the electronic device 100. Instead, the sub-spectrum management device waits to be online before sending. Such sub-spectrum management device may send the spectrum statistical information periodically (for example, according to a pre-configured period) or aperiodically (for example, when switching from an offline state to an online state).

The spectrum usage statistical information received by the communication unit 110 includes spectrum usage related information of the secondary system managed by the sub-spectrum management device and interference related information of the secondary system managed by the sub-spectrum management device. For example, the spectrum usage related information of the secondary system may be acquired by the sub-spectrum management device according to the historical information about spectrum usage saved by the sub-spectrum management device. This is because the sub-spectrum management device manages the spectrum usage of the secondary system, and the historical information stored by the sub-spectrum management device indicates the spectrum usage of the secondary system. Alternatively, the spectrum usage related information of the secondary system may be acquired from the secondary system (that is, the base station of the secondary system) by the sub-spectrum management device. For example, the interference related information of the secondary system may be obtained by measuring the interference suffered by the secondary system. This measurement may be performed under the control of the sub-spectrum management device. Preferably, the interference related information of the secondary system in the spectrum usage statistical information received by the communication unit indicates the interference suffered by the secondary system determined by measurement.

Based on the spectrum usage statistical information acquired by the communication unit 110 from the multiple sub-spectrum management devices, the generation unit 120 statistically understands the spectrum usage and the interference conditions of the secondary systems managed by the respective sub-spectrum management devices, and generate spectrum usage guidance information accordingly.

For example, the electronic device 100 acquires spectrum usage statistical information from three sub-spectrum management devices A, B, and C. The communication unit 110 of the electronic device 100 may periodically acquire spectrum usage statistical information from the device A that is in an offline state, and may acquire spectrum usage statistical information in real time or periodically from the device B and the device C that are always online. For example, after the communication unit 110 periodically acquires the above information, the generation unit 120 may compare the interference related information of the secondary system in the spectrum usage statistical information of the sub-spectrum management device A with the spectrum usage related information of the secondary system in the spectrum usage statistical information of the sub-spectrum management devices B and C; determine that the interference suffered by the secondary system managed by the device A is from the spectrum usage of the secondary systems managed by the device B or C in a case of overlapping; and generate the spectrum usage guidance information to instruct to modify the spectrum usage of the secondary systems managed by the device B or C so as to avoid interference. In addition, the generation unit 120 may, for example, compare the spectrum usage related information of the secondary system in the spectrum usage statistical information of the sub-spectrum management devices A, B, and C, for example, compares the times or frequencies of spectrum usage of the secondary systems managed by the devices A, B, and C, respectively; and generates spectrum usage guidance information instructing these secondary systems to perform more prioritized spectrum usage when the secondary systems managed by the device A have longer spectrum usage or more frequent spectrum usage.

The communication unit 110 may send the spectrum usage guidance information generated by the generation unit 120 to the sub-spectrum management device periodically (for example, according to a pre-configured period) or aperiodically (for example, when the sub-spectrum management device switches from an offline state to an online state), for the sub-spectrum management device to determine the spectrum usage of the secondary system.

In this way, even in the case where some sub-spectrum management devices do not communicate with the central spectrum device in real time, the electronic device 100 according to the embodiment of the present disclosure can acquire spectrum usage statistical information of the secondary systems managed by each sub-spectrum management device from the sub-spectrum management device. This information is considered in an overall manner to give appropriate guidance on the spectrum usage of the secondary systems, which in turn facilitates the coordination of the spectrum usage of the secondary systems.

The basic configuration of the configuration example of the electronic device on the side of the central spectrum device according to the embodiment of the present disclosure has been described above with reference to FIG. 1.

### 2.1.2 Configuration Example of a Generation Unit of an Electronic Device on a Side of a Central Spectrum Device

In a preferred embodiment of an electronic device such as that shown in FIG. 1 on the side of the central spectrum device, in the spectrum usage statistical information received by the communication unit, the spectrum usage related information of the secondary system may indicate an area, a frequency band and a time of spectrum usage of the secondary system, and the interference related information of the secondary system may indicate an area, a frequency band and a time of interference suffered by the secondary system. For example, the spectrum usage related information of the secondary system may include a geographic location, a coverage, as well as a time and a frequency band of spectrum usage of a base station in the secondary system. Accordingly, in a preferred example, the generation unit of the electronic device may generate appropriate spectrum usage guidance information based on such spectrum usage statistical information. Next, one configuration example of a generation unit capable of realizing such processing is described.

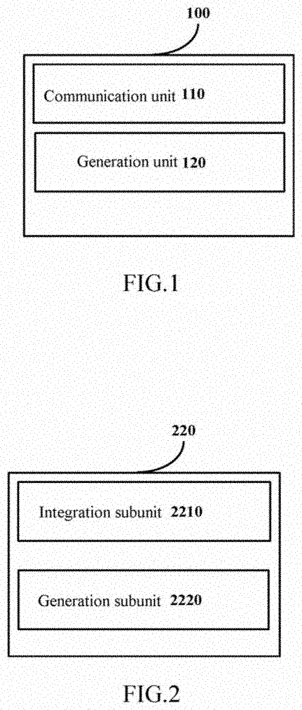

FIG. 2 is a block diagram illustrating a configuration example of a generation unit in an electronic device on a side of a central spectrum device according to an embodiment of the present disclosure. The generation unit 220 shown in FIG. 2 is a configuration example of the generation unit 120 of the electronic device 100 in FIG. 1 based on the above preferred embodiment. The following description therefore continues on the basis of FIG. 1 and the preferred embodiment described above.

As shown in FIG. 2, the generation unit 220 includes an integration subunit 2210 and a generation subunit 2220.

The integration subunit 2210 may determine interference integration information associated with the area and the frequency band based on the spectrum usage statistical information from the multiple sub-spectrum management devices. More specifically, the integration subunit may be configured to: exclude, based on spectrum usage statistical information from the multiple sub-spectrum management devices, from interference suffered by a secondary system managed by each sub-spectrum management device, a portion whose area, frequency band and time overlap an area, a frequency band and a time of spectrum usage of a secondary system managed by another sub-spectrum management device, and determine a result of the excluding as interference from unknown sources suffered by the secondary system managed by each sub-spectrum management device; and accumulate, with respect to all the determined interference from unknown sources, times of respective interference from unknown sources in terms of an area and an frequency band, to determine interference integration information associated with the area and the frequency band.

Optionally, the integration in unit 2210 is further configured to accumulate, based on the spectrum usage statistical information from the multiple sub-spectrum management devices, for each sub-spectrum management device, a time of spectrum usage of a secondary system managed by that sub-spectrum management device in terms of an area, to determine spectrum usage integration information associated with the area.

The generation subunit 2220 may generate, based on the interference integration information acquired by the integration subunit 2210 and optionally in combination with the spectrum usage integration information acquired by the integration subunit 2210, frequency band recommendation information associated with the area for the secondary system managed by each sub-spectrum management device, as the spectrum usage guidance information.

An embodiment of the processing performed by the integration subunit 2210 and the generation subunit 2220 is described below with reference to a specific example. Here, as an example of multiple sub-spectrum management devices, sub-spectrum management devices A, B, and C respectively manage secondary systems {a₁, a₂, . . . , aₘ}, . . . , {c₁, c₂ . . . , cₖ}. a₁, a₂, . . . aₘ, b₁, b₂ . . . bₙ, c₁, c₂, . . . , cₖ represent the secondary systems managed by the sub-spectrum management devices A, B, and C, respectively. m, n, and k are the total number of secondary systems managed by the sub-spectrum management devices A, B, and C, respectively. At least the sub-spectrum management device A is an offline state of not communicating with the electronic device on the side of the central spectrum device in real time.

In this example, the spectrum usage statistical information of the secondary system received from each sub-spectrum management device by the communication unit 110 of the electronic device 100 such as shown in FIG. 1 may include two lists. The first list List1 indicates spectrum usage related information of each secondary system managed by the sub-spectrum management device. The second list List2 indicates the interference related information of each secondary system managed by the sub-spectrum management device.

For the sub-spectrum management device A, an item in the first list List1_{A} indicating spectrum usage related information may correspond to the usage of a frequency band in an area by a secondary system managed by the sub-spectrum management device A, and the form may be, for example, (a serial number of the sub-spectrum management device, a serial number of the secondary system, an area, a frequency band, duration from start to end of the spectrum usage). If the spectrum usage of a secondary system, for example, a secondary system a₁, involves multiple areas and/or multiple frequency bands, there may have multiple items in the first list List1_{A}. Here, the area may be, for example, a serial number of a geographic grid obtained by the sub-spectrum management deice A dividing the geographic area covered by the management of the sub-spectrum management device A (for example, the geographic area corresponding to a geographic location database pre-installed in the sub-spectrum management device A) according to the pre-configuration of the electronic device serving as the central spectrum device. Alternatively, the area may also be indicated by the actual geographic location information of the geographic grid to which the spectrum usage corresponds.

Optionally, as a variant, an item in the first list List1_{A} of the sub-spectrum management device A indicating spectrum usage related information may indicate the spectrum usage of a base station of one of its secondary systems, and the form may be, for example, (a serial number of the sub-spectrum management device, a serial number of the secondary system, a serial number of the base station, a geographic location of the base station, a coverage of the base station, a frequency band, and duration from start to end of the spectrum usage). In this case, the integration subunit 2210 of the electronic device on the side of the central spectrum device may determine the corresponding area according to the geographic location of the base station and the coverage of the base station in the item, and converts all items for the base station individually or collectively into the form of the items for the secondary system described above (a serial number of the sub-spectrum management device, a serial number of the secondary system, an area, a frequency band, and duration from start to end of spectrum usage).

An item in the second list List2_{A} of the spectrum management device A indicating the interference related information may correspond to the interference of a frequency band in an area of the secondary system managed by the sub-spectrum management device A, the form may be, for example, (a serial number of the sub-spectrum management device, a serial number of interference, an area, a frequency band, duration from start to end of the interference), and may optionally include interference strength. The area here may also be the serial number of the geographic grid obtained by dividing the geographic area by the sub-spectrum management device according to the predetermined rules. Alternatively, the area may also be indicated by the actual geographic location information of the geographic grid to which the interference corresponds.

Similarly, the spectrum usage statistical information of the secondary systems managed by the sub-spectrum management device B and C received form the sub-spectrum management device B and C may include first and second lists List1_{B} and List2_{B} and first and second lists Listic and List2_{C}, respectively.

The integration subunit 2210 may integrate the first lists Listic to Listic indicating spectrum usage related information, thereby obtaining a first general table LIST1 including spectrum usage related information of all secondary systems. Each item in LIST1 corresponds to one item from one of Listic to Listic.

In addition, the integration subunit 2210 may summarize and integrate the second lists List2_{A} to List2_{C} indicating spectrum usage related information, so as to obtain a second overall list LIST2 indicating the interference suffered by all secondary systems. Here, in a case that an item in the second lists List2_{A} to List2_{C} indicates repeated interference, the item deleted without being aggregated to the second general table LIST2. For example, assuming that an item in the second list List2_{A} has exactly the same “area”, “frequency band” and “duration from start to end of the interference” as an item in the second list List2_{B}, the two items come from the same interference source, and therefore only one of the two items is stored in the second summary table LIST2.

Further, based on the first general table LIST1 and the second general table LIST2, the integration subunit 2210 excludes the interference in the second general table LIST2 caused by the spectrum usage in the first general table LIST1 by comparing respective items in the first general table LIST1 and the second general table LIST2, so as to determine all the interference from unknown sources except the interference caused by the secondary systems managed by each sub-spectrum management device, and acquires a list of interference from unknown sources LIST0.

In an example, in a preferred embodiment, the integration subunit 2210 performs the following exclusion processing based on the first general tables LIST1 and LIST2: removing an interference item in the second general table LIST2 for indicating interference, in a case that “an area”, “a frequency band”, “duration from start to end of the interference” in the interference item overlap “an area”, “a frequency band”, and “duration from start to end of the interference” in a spectrum usage item in the first general table LIST1 for indicating spectrum usage; and in a case that “area”, “frequency band”, “duration from start to end of the interference” in the interference item partly overlap “area”, “frequency band”, and “duration from start to end of the spectrum usage” in a spectrum usage item in the first general table LIST1 for indicating spectrum usage respectively, removing a part that overlaps a corresponding part in the spectrum usage item from each of the “area”, “frequency band”, “duration from start to end of the interference” in the interference item. After such exclusion processing, a list LIST0 representing interference from all unknown sources is obtained. The form of each item is identical to that in the second general list LIST2, that is, the second list List2, and including (a serial number of the sub-spectrum management device, a serial number of the interference, an area, a frequency band, and duration from start to end of the interference), and may optionally include interference strength.

The integration subunit 2210 may accumulate the time of the corresponding interference form unknown source in terms of the area and the frequency band based on the list LIST0 indicating interference from all unknown sources, so as to determine interference integration information associated with the area and the frequency band.

In an example, the integration subunit 2210 may calculate interference integration information in the form of interference probability associated with areas and frequency bands. In this case, the integration subunit 2210 may count all the interferences that occur for all the items in the list LIST0 according to the combination of (“area” plus “band”), and accumulate the time of the corresponding interference from unknown source. For example, t items in the list LIST0 relate to a given area Areal and frequency band CH1, and the “duration form start to end of interference” in each of the t items us accumulated to obtain the accumulated duration after the repetition period is removed. The accumulated time period may be divided by a preset measurement period for interference measurement (for example, 24 hours) to obtain the interference probability of the frequency band CH1 in the given area Areal. In this way, the interference probability of a frequency band CH1 in a given area is 0.1/24=0.04%, the interference probability of a frequency band CH2 in the given area is 2.1/24=0.09%, and so on. In this way, the interference probability for each frequency band within the area can be calculated.

Optionally, in a case that each item in the list LIST0 further includes the interference intensity, the integration subunit 2210 considers only an interference item whose interference intensity exceeds a predetermined intensity threshold and excludes an item whose interference intensity is relatively low when calculating the interference probability, which is not described in detail herein.

Based on the interference integration information in the form of the interference probability obtained by the integration subunit 2210, the generation subunit 2220 may generate the frequency band recommendation information associated with the area for the secondary system managed by each sub-spectrum management device, as the spectrum usage guidance information. For example, the frequency band recommendation information may include recommended frequency bands arranged in order of priority. For example, the frequency band recommendation information may include a list of frequency bands ordered from low to high interference probability for each area, such as {CH1, CH2, CH3, CH4, . . . CHL} for the given area Areal. Alternatively, the frequency band recommendation information may only include a list of frequency bands in each area whose interference probability is lower than the predetermined interference probability threshold, such as only {CH1, CH2, CH3, CH4} for the given area Areal. Each sub-spectrum management device may determine the spectrum usage of the secondary system managed by the sub-spectrum management device based on such frequency band recommendation information associated with the area.

In this way, the configuration example of the generation unit shown in FIG. 2 can determine the interference from unknown sources other than the interference caused by the secondary system managed by each sub-spectrum management device, and provides appropriate guidance to the spectrum usage of the secondary system according to such interference, so that the secondary system managed by each sub-spectrum management device can be protected from unknown interference.

In addition, optionally, in a further preferred embodiment of the generation unit, the integration subunit 2210 may further determine, for each sub-spectrum management device, determine spectrum usage integration information associated with area based on spectrum usage statistical information from the multiple sub-spectrum management devices, respectively. For example, the integration subunit 2210 may accumulate, based on the first list List1 indicating spectrum usage related information in the spectrum usage statistical information from each sub-spectrum management device, duration of spectrum usage of all the secondary systems managed by the sub-spectrum management device according to the area, determine the probability of spectrum usage associated with the area for the sub-spectrum management device (also referred to as an activation probability associated with the sub-spectrum management device) in a manner similar to determining the interference probability, and determine the activation probability associated with the sub-spectrum management device as the spectrum usage integration information.

More specifically, in an example, taking the sub-spectrum management device A as an example, the integration subunit 2210 may count the spectrum usage that occurs in units of “areas” for all the items in the first list List1_{A}. For example, if s items in the list List1_{A} relate to the given area Areal, the respective “duration form start to end of the spectrum usage” in the s items are accumulated to obtain the accumulated duration after removing the repetition time. The accumulated duration may be divided by a preset statistical period for spectrum usage (for example, 24 hours) to obtain the activation probability of all secondary systems managed by the sub-spectrum management device A in the given area Areal, for example, 20/24=83%. Similarly, for example, the activation probability of a sub-spectrum management device B in the given area Areal is obtained as 50%, and the activation probability of a sub-spectrum management device C in the given area Areal obtained as 20%. In this way, for each area, the activation probability of each sub-spectrum management device within the area can be calculated.

After the integration subunit 2210 acquires the integrated spectrum usage related information in the form of the above activation probability, the generation subunit 2220 generates, for each area, frequency band recommendation information based on the interference integration information in combination with the spectrum usage integration information according to a principle that the sub-spectrum management device with a high activation probability preferentially obtains a frequency band with a low interference probability. For example, the generation subunit 2220 may, according to the activation probability obtained by the integration subunit 2210, provide a sequence of sub-spectrum management devices {sub-spectrum management device A, sub-spectrum management device B, and sub-spectrum management device C sequentially} in descending order of the activation probability for the given area Areal. In addition, the generation subunit 2220 may give a sequence of frequency bands {CH1, CH2, CH3, CH4, . . . , CHL} from low to high interference probability for the given area Areal according to the interference probability obtained by the integration subunit 2210. Therefore, for the given area Areal, the frequency band recommendation information generated by the generation subunit 2220 for the sub-spectrum management device A may indicate recommended frequency bands {CH1, CH2}, the frequency band recommendation information generated by the generation subunit 2220 for the sub-spectrum management device B may indicate the recommended frequency bands {CH3, CH4}, and the frequency band recommendation information generated by the generation subunit 2220 for the sub-spectrum management device C may indicate the recommended frequency band {CH5}. Optionally, the generation subunit 2220 also considers the principle of spectrum continuity when generating the spectrum usage guidance information, which is not described in detail here.

In this way, in the further preferred embodiment of the generation unit, the interference from unknown sources and the spectrum usage of the secondary system managed by each sub-spectrum management device are comprehensively considered. In addition, appropriate guidance is given to the spectrum usage of the secondary systems, so that the secondary systems managed by each sub-spectrum management device can avoid conflict with each other and interference from unknown sources.

### 2.2 Configuration Example of an Electronic Device on a Side of a Sub-Spectrum Management Device Side

### 2.2.1 First Configuration Example of the Electronic Device on the Side of the Sub-Spectrum Management Device

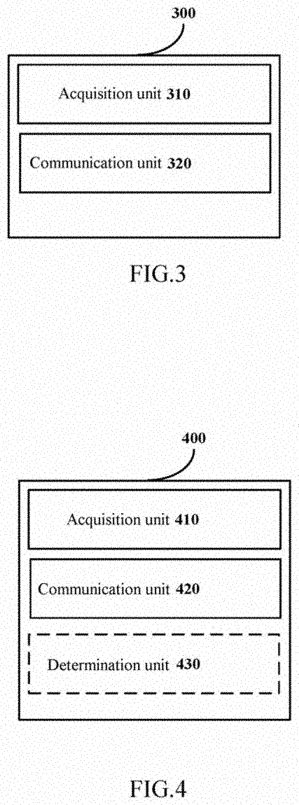

FIG. 3 is a block diagram illustrating a first configuration example of an electronic device on a side of a sub-spectrum management device according to an embodiment of the present disclosure.

As shown in FIG. 3, the electronic device 300 includes an acquisition unit 310 and a communication unit 320.

Here, each unit of the electronic device 300 may be included in the processing circuitry. It should be noted that the electronic device 300 may include either one processing circuitry or multiple processing circuitry. Further, the processing circuitry may include various discrete functional units to perform various functions and/or operations. It should be noted that these functional units may be physical entities or logical entities, and units with different names may be implemented by the same physical entity.

The acquisition unit 310 may acquire spectrum usage statistical information. The spectrum usage statistical information includes, for example, spectrum usage related information of a secondary system managed by the electronic device 300 serving as a sub-spectrum management device and interference related information of the managed secondary system. The communication unit 320 may transmit the acquired spectrum usage statistical information to the central spectrum device, for the central spectrum device to generate spectrum usage guidance information for the secondary system managed by each electronic device based on the spectrum usage statistical information from at least one electronic device (for example, multiple sub-spectrum management devices). The least one electronic device is in an offline state. In an example, here, the offline state may indicate a state of not communicating in real time with the central spectrum device.

Here, “at least one of the electronic devices” including the subject electronic device 300 is in an offline state, so that the spectrum usage statistical information sent by the communication unit of the electronic device to the central spectrum device may not be acquired in real time by the acquisition unit of the electronic device. For example, such electronic device may be pre-installed with information from a geolocation database and deployed locally (for example, a local server or local computer), acquire the spectrum usage statistical information of the managed secondary system through the acquisition unit in an offline state, and transmit the spectrum usage statistical information to the central spectrum device through the communication unit when the electronic device is online rather than in real time. Such electronic devices may transmit the spectrum usage statistical information periodically (for example, according to a pre-configured period) or aperiodically (for example, when switching from an offline state to an online state).

In this way, even in the case where some sub-spectrum management devices including the subject electronic device do not communicate with the central spectrum device in real time, the electronic device 300 according to the embodiment of the present disclosure can provide the central spectrum device with the spectrum usage statistical information of the secondary systems managed by the electronic device 300 appropriately, for the central spectrum device to take into account the information from the various sub-spectrum management devices as a whole to give appropriate guidance to the spectrum usage of the secondary systems.

The acquisition unit 310 of the electronic device 300 shown in FIG. 3 can acquire the spectrum usage statistical information in various appropriate ways, that is, acquire the spectrum usage related information of the secondary system managed by the electronic device 300 and the interference related information of the secondary system managed by the electronic device 300. In an example, the spectrum usage related information of the secondary system may be acquired by the electronic device 300 according to the historical information about spectrum usage stored by the electronic device 300. This is because the electronic device 300 manages the spectrum usage of the secondary system, and the historical information indicates the spectrum usage of the secondary system. Alternatively, the spectrum usage related information of the secondary system may be acquired by the electronic device 300 from the secondary system (that is, a base station of the secondary system) managed by the electronic device 300. Preferably, the interference related information of the secondary system acquired by the acquisition unit 310 indicates the interference suffered by the secondary system determined through measurement. In an example, the interference related information of the secondary system may be obtained by measuring the interference suffered by the secondary system under the control of the electronic device 300.

In a preferred embodiment, the spectrum usage related information of the secondary system acquired by the acquisition unit 310 may indicate an area, a frequency band and a time of the spectrum usage of the secondary system. The interference related information of the secondary system acquired by the acquisition unit 310 may indicate an area, a frequency band and time of the interference suffered by the secondary system. In an example, the spectrum usage related information of the secondary system may include a geographic location, a coverage, as well as a time and a frequency band of spectrum usage of a base station of the secondary system.

In this case, the acquisition unit 310 may acquire the spectrum usage related information of the secondary system, for example, by reading the spectrum usage of the secondary system in different areas and different time and different frequency bands recorded by the electronic device 300 during the spectrum usage of the secondary system. Alternatively, the acquisition unit 310 may receive spectrum usage related information indicating the area, frequency band and time of spectrum usage of the secondary system from the secondary system (that is, the base station of the secondary system) managed by the electronic device 300.

In addition, the acquisition unit 310 may control a spectrum scanning device to perform spectrum scanning on operation environment of the secondary systems during the operation process of the secondary systems, so as to obtain the interference information on each frequency band as the interference related information of the secondary systems.

More specifically, in one example, during the spectrum usage process of the secondary system managed by the electronic device 300, the acquisition unit 310 may, for example, divide the geographic area (for example, the geographic area corresponding to the geographic location database pre-installed in the electronic device 300) covered by the management of the electronic device 300 into multiple geographic grids according to the pre-configuration of the central spectrum device, and record the spectrum usage related information in each geographic grid. The spectrum usage related information includes spectrum scan duration (may also be referred to as measurement period, preferably a same measurement period for all spectrum scan) on different frequency bands (or channels), detected interference intensity, and duration from start to end of the interference in each geographic grid. It should be noted that during the scanning process, the electronic device 300 controls each secondary system managed by the electronic device 300 to be silent. Therefore, the interference caused by other systems (e.g., the secondary systems managed by other sub-spectrum management device, or unknown interference sources) other than the secondary systems managed by the electronic device 300 is actually measured.

The spectrum usage statistical information acquired by the acquisition unit 310 in this way and transmitted by the communication unit 320 may include two lists. A first list List1_{A} indicates spectrum usage related information of each secondary system managed by the electronic device 300. The second list List2_{A} indicates the interference related information of the respective secondary systems managed by the electronic device 300.

More specifically, an item in the first list List1_{A} indicating the spectrum usage related information may correspond to the usage of a frequency band by a secondary system managed by the electronic device 300 in an area, and is in a form, for example, including (a serial number of a sub-spectrum management device corresponding to the electronic device 300, a serial number of the secondary system, an area, a frequency band, duration from start to end of the spectrum usage). Here, the area may be, for example, a serial number of a geographic grid obtained by the electronic device 300 dividing a geographic area based on a pre-determined configuration according to the pre-configuration of the electronic device serving as the central spectrum device. Alternatively, the area may also be indicated by the actual geographic location of the geographic grid to which the spectrum usage corresponds.

Optionally, as a variant, an item in the first list List1_{A} indicating spectrum usage related information may indicate spectrum usage of a base station of a secondary system managed by the electronic device 300, and is in a form, for example, including (a serial number of a sub-spectrum management device corresponding to the electronic device 300, a serial number of the secondary system, a serial number of a base station, a geographic location of the base station, a coverage of the base station, a frequency band, and duration from start to end of the spectrum usage). In this case, the electronic device on the side of the central spectrum device determines the corresponding area according to the geographic location of the base station and the coverage of the base station in the item, and converts the items about the base station individually or collectively into the form of the items about the secondary system described above (that is, a serial number of a sub-spectrum management device, a serial number of the secondary system, an area, a frequency band, duration from start to end of the spectrum usage).

In addition, an item in the second list List2_{A} indicating the interference related information may correspond to the interference of a frequency band suffered by the secondary system managed by the electronic device in an area, and is in the form of (a serial number of the sub-spectrum management device, a serial number of interference, an area, a frequency band, duration from start to end of the interference), and may optionally include interference strength. The area here may also be the serial number of the geographic grid obtained by dividing the geographic area by the sub-spectrum management device according to the predetermined rules. Alternatively, the area may also be indicated by the actual geographic location of the geographic grid to which the interference corresponds.

The first configuration example of the electronic device on the side of the sub-spectrum management device according to the embodiment of the present disclosure is described above with reference to FIG. 3.

### 2.2.2 Second Configuration Example of the Electronic Device on the Side of the Sub-Spectrum Management Device

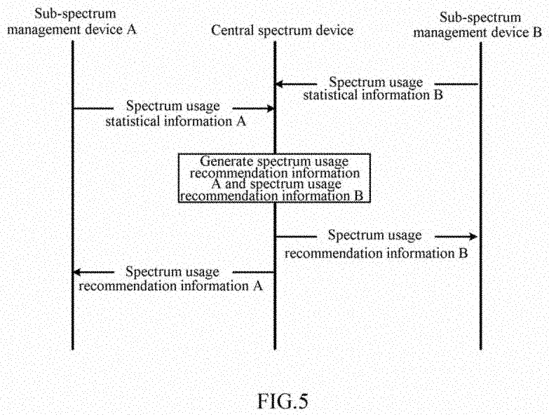

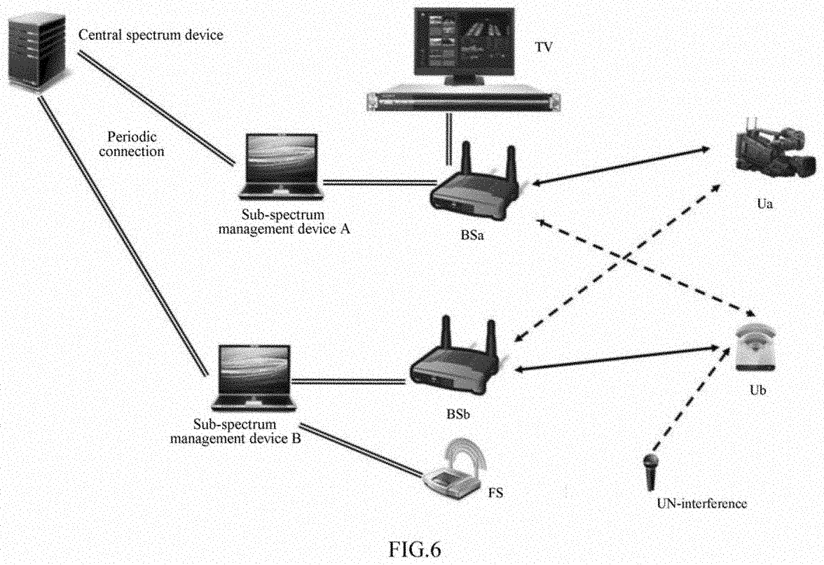

FIG. 4 is a block diagram illustrating a second configuration example of an electronic device on a side of a sub-spectrum management device according to an embodiment of the present disclosure. The second configuration example shown in FIG. 4 is a further improved example based on the first configuration example shown in FIG. 3. Therefore, the following description is made on the basis of the first configuration example shown in FIG. 3 above.

As shown in FIG. 4, the electronic device 400 may include an acquisition unit 410 and a communication unit 420, which are respectively similar to the acquisition unit 310 and the communication unit 320 in the electronic device 300 shown in FIG. 3. In addition, the electronic device 400 optionally includes a determination unit 430. In this configuration example, the communication unit 320 is configured to receive the spectrum usage guidance information generated by the central spectrum device from the central spectrum device. The determination unit 430 is configured to determine the spectrum usage of the secondary system managed by the electronic device 400 with reference to the spectrum usage guide information generated by the central spectrum device.

Here, the determination unit 430 has the basic function of calculating the available spectrum resources of the secondary system of the general (sub) spectrum management device. For example, the determination unit 430 may calculate the interference of the secondary system to the primary system based on factors such as the geographic location of the secondary system, the geographic location of the primary system to be protected, the spectrum usage (e.g., transmit power, antenna height, transmission template) of the secondary system to the primary system, and calculates the available spectrum resources for the secondary system according to the calculated interference.

Furthermore, in this configuration example, the communication unit 320 receives the spectrum usage guide information generated by the central spectrum device from the central spectrum device. Therefore, the determination unit 430 can comprehensively consider the available spectrum resources calculated according to the interference to the primary system and the spectrum usage guidance information generated by the central spectrum device, so as to optimally determine the final spectrum usage of the secondary system. As an example, the determination unit 430 may determine the spectrum resource finally utilized by the secondary system from the calculated available spectrum resources based on the spectrum usage guide information.

The second configuration example of the electronic device on the side of the sub-spectrum management device according to the embodiment of the present disclosure has been described above with reference to FIG. 4.

It should be noted that the electronic devices 300 and 400 on the side of the sub-spectrum management device described with reference to FIGS. 3 and 4 may be served by the electronic device 100 (including the functional units in the electronic device on the side of the central spectrum device described with reference to FIG. 2) on the side of the central spectrum device described with reference to FIG. 1 and interact with the electronic device 100. Therefore, the above-described configuration examples of the electronic device on the side of the central spectrum device and related embodiments are appropriately applied to the electronic devices 300 and 400 on the side of the sub-spectrum management device.

### 2.3 Example of Information Exchange Process on a Centralized Spectrum Management Mode

Next, an example of an information exchange process in a centralized spectrum management mode according to an embodiment of the present disclosure is described with reference to FIG. 5.

FIG. 5 is a schematic diagram illustrating an example of an information exchange process of centralized spectrum management according to an embodiment of the present disclosure. FIG. 5 schematically shows a central spectrum device and two sub-spectrum management devices A and B. As shown in FIG. 5, the sub-spectrum management devices A and B send respective spectrum usage statistical information A and B to the central spectrum device. The spectrum usage statistical information includes spectrum usage related information of the secondary system managed by the sub-spectrum management device and interference related information of the secondary system managed by the corresponding sub-spectrum management device. The central spectrum device generates spectrum usage guidance information A for the secondary system managed by the sub-spectrum management device A based on the spectrum usage statistical information A from the sub-spectrum management device A, and transmits the spectrum usage guidance information A to the sub-spectrum management device A. The central spectrum device generates spectrum usage guidance information B for the secondary system managed by the sub-spectrum management device B based on the spectrum usage statistical information B from the sub-spectrum management device B, and transmits the spectrum usage guidance information A to the sub-spectrum management device B. Here, for example, at least the sub-spectrum management device A has an offline state. The central spectrum device therefore communicates with the sub-spectrum management device A periodically or only when the sub-spectrum management device A is online. The example flow shown in FIG. 5 may be implemented by each configuration example of the electronic device in the centralized spectrum management mode described above with reference to FIGS. 1 to 4, and thus is not described further here.

### 2.4 Example Application Scenario in the Centralized Spectrum Management Mode

Next, an example of an information exchange process in a centralized spectrum management mode according to an embodiment of the present disclosure is described with reference to FIG. 6.

FIG. 6 is a schematic diagram illustrating an example application scenario of the centralized spectrum management according to an embodiment of the present disclosure. As shown in FIG. 6, under the management of the central spectrum device, the two sub-spectrum management devices A and B manage their respective secondary system a and secondary system b to access an idle frequency band of the primary system TV (television system). The sub-spectrum management devices A and B are pre-installed with the information of the geographic location database and deployed on the local computer, and only communicate with the central spectrum device periodically. The secondary system a managed by the sub-spectrum management device A includes a base station BSa and a terminal device Ua such as a camera. The secondary system b managed by the sub-spectrum management device B includes a base station BSb and a terminal device Ub. FIG. 6 also schematically shows a spectrum scanning device FS equipped for the sub-spectrum management device B. Although not shown in FIG. 6, the sub-spectrum management device A may also be equipped with a similar spectrum scanning device. In the example scenario shown in FIG. 6, there is an unknown interference source UN-interference, for example, a microphone, which is not managed by any spectrum management device. The unknown interference source UN-interference also accesses the idle spectrum of the TV of the primary system as a secondary system.

In the example scenario shown in FIG. 6, the central spectrum device may be implemented, for example, by the electronic device 100 described with reference to FIG. 1, including the generation unit 220 in the electronic device described with reference to FIG. 2. For example, the sub-spectrum management devices A and B may each be implemented by the electronic device 300 or 400 as described above with reference to FIG. 3 and FIG. 4. Correspondingly, the central spectrum device and the sub-spectrum management devices A and B may jointly implement the centralized spectrum management according to, for example, the signaling interaction process shown in FIG. 5.

More specifically, in this example, the spectrum usage statistical information obtained by the central spectrum device from each sub-spectrum management device may include two lists, namely, a first list List1 indicating spectrum usage related information and a second list List2 indicating interference related information.

The central spectrum device may aggregate the first lists List1_{A} and List1_{B} respectively from the sub-spectrum management devices A and B in the specific manner in the configuration example of the generation unit 220 described with reference to FIG. 2 so as obtain a first general table LIST1 including spectrum usage related information of secondary systems a and b; and aggregates and integrates the second lists List2_{A} and List2_{B} respectively from the sub-spectrum management devices A and B so as to obtain a second general list LIST2 indicating the interference suffered by the secondary systems a and b. Based on the first general table LIST1 and the second general table LIST2, the central spectrum device can determine the interference from unknown source IN-interference other than the interference caused by the secondary systems a and b in the specific manner in the configuration example of the generation unit 220 described with reference to FIG. 2 by excluding interference caused by the spectrum usage of the secondary systems a and b, and acquire a list LIST0 of interference from unknown sources. LIST0 may include interference items for IN-interference. Based on the list LIST0 of interference from unknown sources, the central spectrum device may determine interference integration information and generate appropriate spectrum usage guidance information based on the interference integration information to coordinate the spectrum usage of secondary systems a and b, thereby protecting secondary systems a and b from IN-interference from unknown sources.

### 3. Configuration Example of an Electronic Device Involved in Distributed Spectrum Management

### 3.1 First Configuration Example of an Electronic Device that May be Utilized for Distributed Spectrum Management

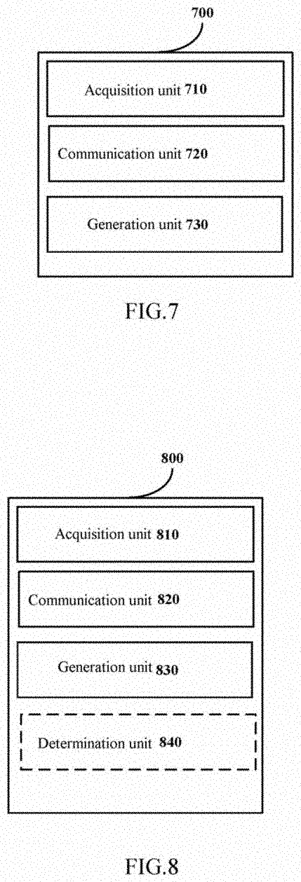

FIG. 7 is a block diagram illustrating a first configuration example of an electronic device that may be utilized for distributed spectrum management according to an embodiment of the present disclosure.

As shown in FIG. 7, the electronic device 700 may include an acquisition unit 710, a generation unit 720, and a communication unit 730.

Here, each unit of the electronic device 700 may be included in processing circuitry. It should be noted that the electronic device 700 may include either one processing circuitry or multiple processing circuitry. Further, the processing circuitry may include various discrete functional units to perform various functions and/or operations. It should be noted that these functional units may be physical entities or logical entities, and units with different names may be implemented by the same physical entity.

The acquisition unit 710 may acquire spectrum usage statistical information of the secondary system managed by the electronic device 700 (e.g., serving as a distributed spectrum management device). The spectrum usage statistical information includes spectrum usage related information of the secondary system managed by the electronic device 700 and interference related information of the secondary system. The communication unit 720 may receive spectrum usage statistical information from another such electronic device (e.g., other distributed spectrum management devices). At least one of the another electronic device is in an offline state. For example, the offline state may indicate a state in which real-time communication between electronic devices is not performed. The generation unit 730 may generate spectrum usage guidance information of the secondary system managed by the electronic device 700 based on the acquired spectrum usage statistical information and the received spectrum usage statistical information.

With reference to the above configuration example of the electronic device in the centralized spectrum management mode, it can be known that in the configuration example of the electronic device 700 for distributed spectrum management shown in FIG. 7, the acquisition unit 710 may have the function of the acquisition unit 310 in the electronic device 300 on the side of the sub-spectrum management device described with reference to FIG. 3. The communication unit 720 may have the function of the communication unit 110 in the electronic device 100 on the side of the central spectrum device described with reference to FIG. 1. The generation unit 730 may have the function of the generation unit 120 in the electronic device 100 on the side of the central spectrum device described with reference to FIG. 1. In addition, it should be understood that the communication unit 720 in the electronic device 700 for distributed spectrum management further transmits the spectrum usage statistical information of the secondary system managed by the electronic device 700 to other distributed spectrum management devices, in addition to receives spectrum usage statistical information from other electronic devices, that is, other distributed spectrum management devices. Therefore, the communication unit 720 also has the function of the communication unit 320 in the electronic device 300 on the side of the sub-spectrum management device described with reference to FIG. 3.

Therefore, it should be understood that various aspects in the above configuration examples regarding the electronic device 100 and the electronic device 300 in the centralized spectrum management mode are appropriately applicable to the electronic device 700 for distributed spectrum management. Only the differences between the electronic device 700 for distributed spectrum management and the electronic device 100 and the electronic device 300 are described below.

For example, for the distributed spectrum management, each distributed spectrum management device such as the electronic device 700 can theoretically calculate the spectrum usage guidance information of the secondary systems managed by all the spectrum management devices with a unified algorithm based on the spectrum usage statistical information of all the spectrum management devices. In practice, however, the generation unit 730 in the electronic device 700 may only perform minimal calculations related to generating the spectrum usage guidance information of the electronic device 700, which is not described in detail here.

The communication unit 720 in the electronic device 700 may be configured to periodically (e.g., according to a preconfigured period) or aperiodically (e.g., when switching from an offline state to an online state) receive spectrum usage statistical information from another electronic device (other distributed spectrum management device). In addition, the communication unit 720 may be configured to periodically or aperiodically transmit the acquired spectrum usage statistical information of the secondary systems managed by the electronic device 700 to the another electronic device (another distributed spectrum management device).

Optionally, the communication unit 720 in the electronic device 700 is further configured to exchange synchronization period information with another electronic device (another distributed spectrum management device). Based on the exchanged synchronization period information, the respective distributed spectrum management devices may employ an appropriate manner to ensure that the spectrum usage statistical information utilized by each distributed spectrum management device to calculate spectrum usage guidance information is updated synchronously.

Preferably, in the spectrum usage statistical information, the interference related information of the secondary system indicates the interference suffered by the secondary system determined through measurement.

Preferably, in the spectrum usage statistical information, the spectrum usage related information of the secondary system indicates an area, a frequency band and a time of the spectrum usage of the secondary system. The interference related information of a secondary system indicates an area, a frequency band, and a time of interference suffered by the secondary system. Optionally, the spectrum usage related information of the secondary system includes a geographic location, a coverage, as well as a time and a frequency band of spectrum usage of a base station of the secondary system.

Preferably, the generation unit 730 may be further configured to: determine interference integration information associated with the area and the frequency band based on the acquired spectrum usage statistical information and the received spectrum usage statistical information.

More specifically, the generation unit 730 may be further configured to: exclude, based on the acquired spectrum usage statistical information and the received spectrum usage statistical information and from interference suffered by a secondary system managed by each electronic device, a portion whose area, frequency band and time overlap an area, a frequency band and a time of spectrum usage of a secondary system managed by another electronic device, and determine the result of the exclusion as the interference from unknown source suffered by the secondary system managed by the electronic device; and for the determined interference from all unknown sources, accumulate the time of the corresponding interference from unknown source in terms of the area and the frequency band to determine the interference integration information associated with the area and the frequency band.

Optionally, the generation unit 730 may be further configured to: based on the acquired spectrum usage statistical information and the received spectrum usage statistical information, for each electronic device, accumulate the time of spectrum usage of a secondary system managed by the electronic device in terms of the area, to determine spectrum usage integration information associated with an area.

Preferably, the generation unit 730 may be further configured to: based on the determined integration information, generate frequency band recommendation information associated with the area for the secondary system managed by the electronic device, as the spectrum usage guidance information.

For example, the frequency band recommendation information generated by the generation unit 730 may include recommended frequency bands arranged in a priority order.

### 3.2 Second Configuration Example of an Electronic Device that May be Utilized for Distributed Spectrum Management

FIG. 8 is a block diagram illustrating a second configuration example of an electronic device that may be utilized for distributed spectrum management according to an embodiment of the present disclosure. The second configuration example shown in FIG. 8 is a further improved example based on the first configuration example shown in FIG. 7, and therefore, the following description is made based on the first configuration example shown in FIG. 7 above.

As shown in FIG. 8, the electronic device 800 may include an acquisition unit 810, a generation unit 820, and a communication unit 830, which are respectively similar to the acquisition unit 710, the generation unit 720, and the communication unit 730 in the electronic device 700 shown in FIG. 7. In addition, the electronic device 800 further includes a determination unit 840. In this configuration example, the determination unit 840 may determine the spectrum usage of the secondary system managed by the electronic device 800 with reference to the spectrum usage guide information generated by the generation unit 720.

With reference to the above configuration example of the electronic device in the centralized spectrum management mode, it can be known that in the configuration example of the electronic device 800 for distributed spectrum management shown in FIG. 8, the determination unit 840 may have the function of the determination unit 430 in the electronic device 400 on the side of the sub-spectrum management device described with reference to FIG. 4. That is, the determination units 840 and 430 both determine the spectrum usage of the managed secondary system based on the spectrum usage guide information. Therefore, various aspects of the above determination unit 430 in the configuration example of the electronic device 400 are appropriately applied to the determination unit 840 of the electronic device 800 for distributed spectrum management, and thus are not repeated here.

### 3.3 Example of Information Exchange Process for Distributed Spectrum Management

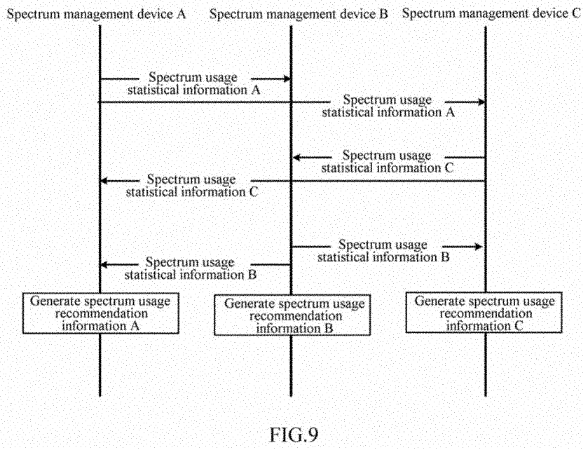

Next, an example of an information exchange process of distributed spectrum management according to an embodiment of the present disclosure is described with reference to FIG. 9.

FIG. 9 is a schematic diagram illustrating an example of an information exchange process of the distributed spectrum management according to an embodiment of the present disclosure. FIG. 9 schematically shows three distributed spectrum management devices A, B, C. As shown in FIG. 9, the spectrum management devices A, B, and C transmit their respective spectrum usage statistical information A, B, and C to other spectrum devices. The spectrum usage statistical information includes spectrum usage related information of the secondary system managed by the corresponding sub-spectrum management device and interference-related information of the secondary system. The spectrum management device A generates spectrum usage guidance information A for the secondary system managed by the spectrum management device A based on the spectrum usage statistical information A and the spectrum usage statistical information received from other spectrum management devices. The spectrum management device B generates spectrum usage guidance information B for the secondary system managed by the spectrum management device B based on the spectrum usage statistical information B and the spectrum usage statistical information received from other spectrum management devices. The spectrum management device C generates spectrum usage guidance information C for the secondary system managed by the spectrum management device C based on the spectrum usage statistical information C and the spectrum usage statistical information received from other spectrum management devices. Here, for example, at least the spectrum management device A has an offline state and thus communicates with other spectrum management devices periodically or only when online. The example flow shown in FIG. 9 may be implemented by each of the configuration examples of the electronic device for distributed spectrum management described above with reference to FIGS. 7 to 8, and thus is not described further here.

### 4. Example of an Electronic Device on a Side of a Base Station in a Secondary System

Corresponding to the centralized spectrum management of the embodiments of the present disclosure described above, there is also provided an electronic device on the base station side in the secondary system according to an aspect of the embodiments of the present disclosure. The electronic device includes a processing circuitry. The processing circuitry is configured to: acquire spectrum usage related information of the secondary system where the electronic device is located; and send the acquired spectrum usage related information to a sub-spectrum management device managing the secondary system, for the sub-spectrum management device to send the spectrum usage related information and the interference related information of the secondary system to the central spectrum device as spectrum usage statistical information, so that the central spectrum device generates spectrum usage guidance information for the secondary systems managed by each sub-spectrum management device based on the spectrum usage statistical information from the at least one sub-spectrum management device. at least one sub-spectrum management device is in an offline state. As an example, here, the offline state may indicate a state of not communicating in real time with the central spectrum device.

In addition, corresponding to the distributed spectrum management of the embodiments of the present disclosure described above, an electronic device on the base station side in the secondary system is also provided according to an aspect of the embodiments of the present disclosure. The electronic device includes processing circuitry configured to: acquire spectrum usage related information of the secondary system where the electronic device is located; and send the obtained spectrum usage related information to a spectrum management device that manages the secondary system, for the spectrum management device to generate spectrum usage guidance information for the secondary system based on the spectrum usage statistical information including the spectrum usage related information and interference related information of the secondary system, and spectrum usage statistical information from other spectrum management devices. At least one of the other spectrum management devices is in an offline state. As an example, here, the offline state may indicate a state of not communicating with the spectrum management device in real time.

Here, the spectrum usage related information of the secondary system where the electronic device on the base station side is located may include spectrum usage related information performed by the base station (together with the terminal device served by the base station), and indicate an area, a frequency band, a time and the like of such spectrum usage. The electronic device on the base station side in the secondary system may acquire this information in any suitable manner. The specific form of the spectrum usage related information provided by the electronic device may be consistent with/compatible with that described in the above embodiments about the central spectrum device, the sub-spectrum management device, and the distributed spectrum management device, and thus is not described in detail here.

### 5. Method Embodiments

Next, the method performed in the electronic device capable of spectrum management according to the embodiment of the present disclosure is described in detail. It should be noted that these method implementations correspond to the device configuration examples described above with reference to FIGS. 1 to 9. Accordingly, the various details and benefits of the above device configuration examples apply as appropriate to the following method embodiments.

### 5.1 Method Embodiments on a Side of a Central Spectrum Device

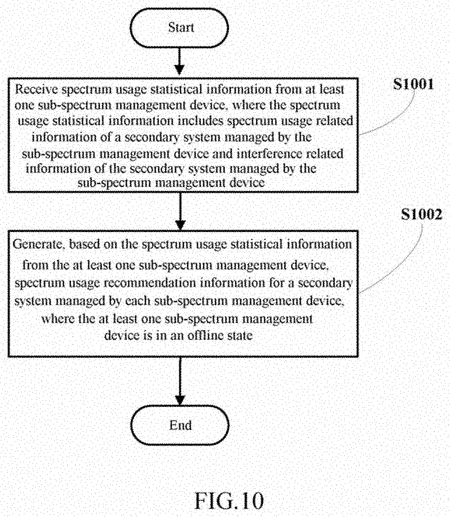

FIG. 10 is a flowchart illustrating a process example of a method in an electronic device on a side of a central spectrum device according to an embodiment of the present disclosure. The method may be implemented, for example, by the electronic device 100 (including the functional units of the electronic device 100 described with reference to FIG. 2) on the side of the central spectrum device described with reference to FIG. 1.

As shown in FIG. 10, in step S1001, spectrum usage statistical information from at least one sub-spectrum management device is received. The spectrum usage statistical information includes spectrum usage related information of a secondary system managed by the sub-spectrum management device and interference related information of the secondary system. Next, in step S1002, spectrum usage guidance information for the secondary system managed by each sub-spectrum management device is generated based on the spectrum usage statistical information from at least one sub-spectrum management device. The at least one sub-spectrum management device is in an offline state. As an example, here, the offline state may indicate a state of not communicating with the electronic device in real time.

Preferably, in the spectrum usage statistical information received in step S1001, the interference related information of the secondary system indicates the interference suffered by the secondary system determined through measurement.

Preferably, the spectrum usage related information of the secondary system indicates an area, a frequency band and a time of the spectrum usage of the secondary system. The interference related information of a secondary system indicates an area, a frequency band, and a time of interference suffered by the secondary system.

Optionally, the spectrum usage related information of the secondary system includes the geographic location, a coverage, as well as a time and a frequency band of spectrum usage of a base station of the secondary system.

Preferably, in step S1002, interference integration information associated with the area and the frequency band may be determined based on spectrum usage statistical information from multiple sub-spectrum management devices.

More specifically, in step S1002, based on spectrum usage statistical information from the multiple sub-spectrum management devices, a portion whose area, frequency band and time overlap an area, a frequency band and a time of spectrum usage of a secondary system managed by another sub-spectrum management device is excluded from interference suffered by a secondary system managed by each sub-spectrum management device, and the result of the excluding is determined as the interference from unknown source suffered by the secondary systems managed by the sub-spectrum management device. In addition, the time of the corresponding interference from unknown source may be accumulated according to area and frequency band for all the determined interference from unknown sources, so as to determine the interference integration information associated with the area and frequency band.

Optionally, in step S1002, based on the spectrum usage statistical information from multiple sub-spectrum management devices, the time of spectrum usage of the secondary system managed by the sub-spectrum management device may be accumulated for each sub-spectrum management device by region, to determine the spectrum usage integration information associated with the area.

Optionally, in step S1002, based on the determined integration information, frequency band recommended information associated with the area for the secondary systems managed by each sub-spectrum management device may be generated as the spectrum usage guidance information.

Preferably, the frequency band recommendation information generated in step S1002 includes recommended frequency bands arranged in order of priority.

According to an embodiment of the present disclosure, the subject performing the above method may be the electronic device 100 (including the functional units of the electronic device described with reference to FIG. 2) according to the embodiment of the present disclosure. Various aspects of the foregoing embodiments of the electronic device 100 and its functional units therefore applicable to here.

### 5.2 Method Embodiments on a Side of a Sub-Spectrum Management Device

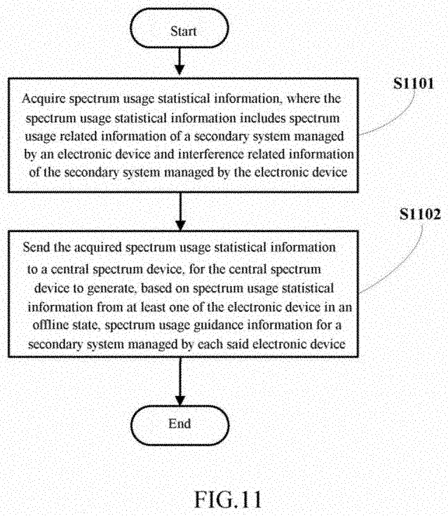

FIG. 11 is a flowchart illustrating a process example of a method in an electronic device on a side of a sub-spectrum management device according to an embodiment of the present disclosure. The method may be implemented by, for example, the electronic devices 300 and 400 on the side of the sub-spectrum management device described with reference to FIGS. 3 and 4.

As shown in FIG. 11, in step S1101, spectrum usage statistical information is acquired. The spectrum usage statistical information includes spectrum usage related information of the secondary system managed by the electronic device (as the sub-spectrum management device) and interference related information of the secondary system. Next, in step S1102, the acquired spectrum usage statistical information is sent to the central spectrum device, for the central spectrum device to generate spectrum usage guidance information for the secondary system managed by each of the electronic devices based on spectrum usage statistical information from at least one of the electronic devices. At least one of the electronic devices is in an offline state. As an example, here, the offline state may indicate a state of not communicating in real time with the central spectrum device.

Preferably, in the spectrum usage statistical information acquired in step S1101, the interference related information of the secondary system indicates the interference suffered by the secondary system determined through measurement.

Preferably, the spectrum usage related information of the secondary system indicates an area, a frequency band and a time of the spectrum usage of the secondary system. The interference related information of the secondary system indicates an area, a frequency band, and a time of the interference suffered by the secondary system.

Optionally, the spectrum usage related information of the secondary system includes a geographic location, a coverage, as well as a time and a frequency band of spectrum usage of a base station of the secondary system.

Optionally, the processing in step S1102 is performed periodically or aperiodically, that is, the acquired spectrum usage statistical information is periodically sent to the central spectrum device.

Optionally, the method performed by the electronic device may further include: determining the spectrum usage of the secondary system managed by the electronic device with reference to spectrum usage guidance information generated by the central spectrum device.

According to an embodiment of the present disclosure, the subject performing the above method may be the electronic devices 300 and 400 according to the embodiment of the present disclosure. The various aspects of the foregoing with respect to the embodiments of electronic devices 300 and 400 therefore are applicable to here.

### 5.3 Method Embodiments in a Distributed Spectrum Management Mode

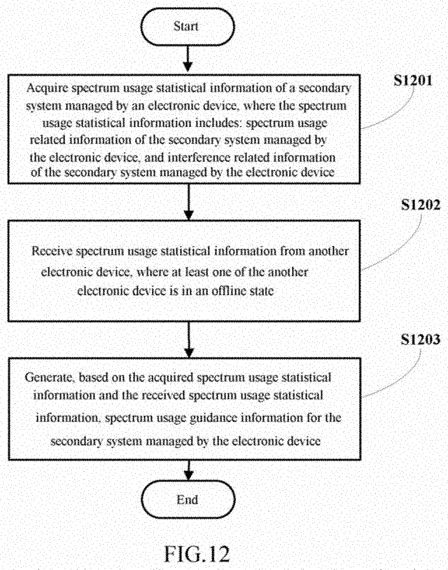

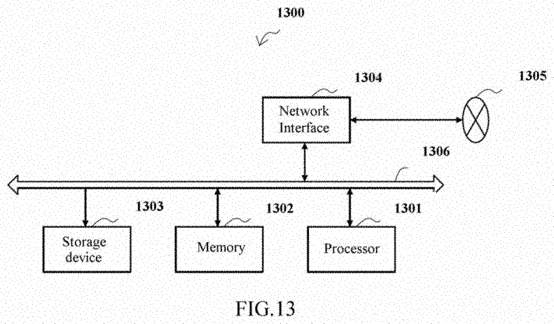

FIG. 12 is a flowchart illustrating a process example of a method that may be utilized in an electronic device for distributed spectrum management according to an embodiment of the present disclosure. The method may be implemented, for example, by the electronic devices 700 and 800 for distributed spectrum management described with reference to FIGS. 7 and 8.

As shown in FIG. 12, in step S1201, the spectrum usage statistical information of the secondary system managed by the electronic device (serving as the distributed spectrum management device) is acquired. The spectrum usage statistical information includes spectrum usage related information of the secondary system managed by the electronic device and interference related information of the secondary system. Next, in step S1202, spectrum usage statistical information from other electronic devices is received. At least one of the other electronic devices is in an offline state. As an example, here, the offline state may indicate a state of not communicating with the electronic device in real time. Next, in step S1203, based on the acquired spectrum usage statistical information and the received spectrum usage statistical information, the spectrum usage guidance information of the secondary system managed by the electronic device is generated.

Preferably, in the spectrum usage statistical information, the interference related information of the secondary system indicates the interference suffered by the secondary system determined through measurement.

Preferably, the spectrum usage related information of the secondary system indicates an area, a frequency band and a time of the spectrum usage of the secondary system. The interference related information of a secondary system indicates the area, frequency band, and time of interference suffered by the secondary system.

Optionally, the spectrum usage related information of the secondary system includes a geographic location, a coverage, as well as a time and a frequency band of spectrum usage of a base station of the secondary system.

Preferably, interference integration information associated with area and frequency band may be determined based on the acquired spectrum usage statistical information and the received spectrum usage statistical information.

More specifically, based on the acquired spectrum usage statistical information and the received spectrum usage statistical information, a portion whose area, frequency band and time overlap an area, a frequency band and a time of spectrum usage of a secondary system managed by another electronic device is excluded from interference suffered by a secondary system managed by each electronic device, and a result of excluding is determined as the interference from unknown source suffered by the secondary systems managed by the electronic device. In addition, the time of the corresponding interference from unknown source may be accumulated according to area and frequency band for all the determined interference from unknown sources, so as to determine the interference integration information associated with the area and frequency band.

Optionally, based on the acquired spectrum usage statistical information and the received spectrum usage statistical information, the time of spectrum usage of the secondary systems managed by the electronic device may be accumulated by area for each of the electronic devices, so as to determine the spectrum usage integration information associated with the area.

Preferably, based on the determined integration information, the frequency band recommendation information associated with the area for the secondary system managed by the electronic device may be generated as the spectrum usage guidance information.

Preferably, the frequency band recommendation information includes recommended frequency bands arranged in order of priority.

Optionally, spectrum usage statistical information may be received from other electronic devices periodically or aperiodically. In addition, the acquired spectrum usage statistical information of the secondary systems managed by the electronic device may be sent to the other electronic devices periodically or aperiodically.

Optionally, synchronization period information may be exchanged with the other electronic devices.

Optionally, the method performed by the electronic device may further include: with reference to the generated spectrum usage guidance information, determining the spectrum usage of the secondary system managed by the electronic device.

According to an embodiment of the present disclosure, the subject performing the above method may be the electronic devices 700 and 800 according to the embodiment of the present disclosure. Accordingly, various aspects of the foregoing with respect to the embodiments of electronic devices 700 and 800 are applicable to here.

### 6. Application Examples

The technology of the present disclosure may be applied to various products.

For example, the electronic device 100, 300, 400, 700, or 800 may be implemented as any type of server, such as a tower server, a rack server, and a blade server. The electronic device 100 may be a control module (such as integrated circuitry module including a single die, and a card or blade inserted into a slot of a blade server) mounted on a server.

For example, the electronic device on the base station side may be implemented as any type of base station device, such as a macro eNB and a small eNB, and may also be implemented as any type of gNB (base station in a 5G system). She small eNB may be an eNB covering a cell smaller than a macro cell, such as a pico eNB, a micro eNB, and a home (femto) eNB. Alternatively, the base station may be implemented as any other type of base station, such as a NodeB and a base transceiver station (BTS). A base station may include: a subject (also referred to as a base station device) configured to control wireless communications; and one or more remote radio heads (RRHs) disposed at a different location than the subject.

In addition, the electronic device on the base station side may also be implemented as any type of TRP. The TRP may have sending and receiving functions, for example, may receive information from user equipment and a base station device, and may also send information to the user equipment and the base station device. In a typical example, the TRP may serve the user equipment and be controlled by the base station device. Further, the TRP may have a structure similar to that of the base station device, or may have only the structure related to sending and receiving information in the base station device.

### Application Example of Server

FIG. 13 is a block diagram illustrating an example of a schematic configuration of a server 1300 to which the technology of the present disclosure may be applied. The server 1300 includes a processor 1301, a memory 1302, a storage device 1303, a network interface 1304 and a bus 1306.

The processor 1301 may be, for example, a central processing unit (CPU) or a digital signal processor (DSP), and controls the functions of the server 1300. The memory 1302 includes a random-access memory (RAM) and a read only memory (ROM), and stores data and programs executed by the processor 1301. The storage device 1303 may include a storage medium such as a semiconductor memory and a hard disk.

The network interface 1304 is a wired communication interface for connecting the server 1300 to a wired communication network 1305. The wired communication network 1305 may be a core network such as an evolved packet core network (EPC) or a packet data network (PDN) such as the Internet.

The processor 1301, the memory 1302, the storage device 1303, and the network interface 1304 are connected to each other via the bus 1306. The bus 1306 may include two or more buses (such as a high-speed bus and a low-speed bus) each having a different speed.

In the server 1300 shown in FIG. 13, the communication units of the electronic devices 100, 300, 700, and 800 described with reference to FIGS. 1, 3, 4, 7, and 8 may be implemented by, for example, the network interface 1304. In addition, at least a part of the functions of the following units may be implemented by the processor 1301 of the server 1300: the generation units of the electronic devices 100, 700, and 800 described with reference to FIG. 1, FIG. 7, and FIG. 8; the acquisition unit of the electronic devices 300, 400, 700, 800 described with reference to FIG. 3, FIG. 4, FIG. 7, and FIG. 8; the determination units of the electronic devices 400 and 800 described with reference to FIG. 4 and FIG. 8, and the like. For example, the processor 1301 may perform the operation of generating the spectrum usage guidance information of the present application by performing the operation of the generation unit.

### Application Examples about Base Station

### First Application Example

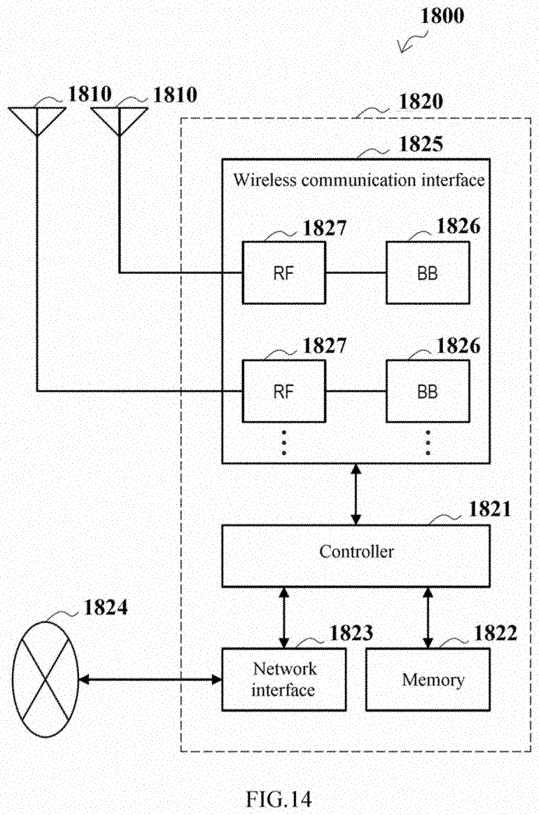

FIG. 14 is a block diagram illustrating a first example of a schematic configuration of an eNB to which the technology of the present disclosure may be applied. The eNB 1800 includes one or more antennas 1810 and a base station device 1820. The base station device 1820 may be connected to each antenna 1810 via an RF cable.

Each of the antennas 1810 includes a single or multiple antenna elements (such as multiple antenna elements included in a multiple-input multiple-output (MIMO) antenna), and is utilized by the base station device 1820 to transmit and receive wireless signals. As shown in FIG. 14, the eNB 1800 may include multiple antennas 1810. For example, multiple antennas 1810 may be compatible with multiple frequency bands utilized by the eNB 1800. Although FIG. 14 shows an example in which the eNB 1800 includes multiple antennas 1810, the eNB 1800 may also include a single antenna 1810.

The base station device 1820 includes a controller 1821, a memory 1822, a network interface 1823, and a wireless communication interface 1825.

The controller 1821 may be, for example, a CPU or a DSP, and operates various functions of a higher layer of the base station device 1820. For example, the controller 1821 generates a data packet from the data in the signal processed by the wireless communication interface 1825, and sends the generated packet via the network interface 1823. The controller 1821 may bundle data from multiple baseband processors to generate a bundled packet, and deliver the generated bundled packet. The controller 1821 may have logical functions to perform controls such as radio resource control, radio bearer control, mobility management, admission control, and scheduling. This control may be performed in conjunction with a nearby eNB or core network node. The memory 1822 includes a RAM and a ROM, and stores programs executed by the controller 1821 and various types of control data such as a terminal list, transmission power data, and scheduling data.

The network interface 1823 is a communication interface for connecting the base station device 1820 to the core network 1824. The controller 1821 may communicate with core network nodes or further eNBs via the network interface 1823. In this case, the eNB 1800 may be connected to the core network node or other eNB via a logical interface such as S1 interface and X2 interface. The network interface 1823 may also be a wired communication interface or a wireless communication interface for wireless backhaul. If the network interface 1823 is a wireless communication interface, the network interface 1823 may use a higher frequency band for wireless communication than the frequency band utilized by the wireless communication interface 1825.

The wireless communication interface 1825 supports any cellular communication scheme, such as Long-Term Evolution (LTE) and LTE-Advanced, and provides wireless connection to terminals located in the cell of the eNB 1800 via the antenna 1810. The wireless communication interface 1825 may generally include, for example, a baseband (BB) a processor 1826 and RF circuitry 1827. The BB processor 1826 may perform, for example, encoding/decoding, modulation/demodulation, and multiplexing/demultiplexing, and performs various types of signal processing of layers (e.g., L1, Medium Access Control (MAC), Radio Link Control (RLC), and Packet Data Convergence Protocol (PDCP)). In place of the controller 1821, the BB processor 1826 may have some or all of the above-described logical functions. The BB processor 1826 may be a memory storing a communication control program, or a module including a processor and associated circuitry configured to execute the program. An update procedure may cause the functionality of the BB processor 1826 to change. The module may be a card or blade that is inserted into a slot of the base station device 1820. Alternatively, the module may be a chip mounted on a card or blade. Further, the RF circuitry 1827 may include, for example, a mixer, a filter, and an amplifier, and transmit and receive wireless signals via the antenna 1810.

As shown in FIG. 14, the wireless communication interface 1825 may include multiple BB processors 1826. For example, the multiple BB processors 1826 may be compatible with multiple frequency bands utilized by the eNB 1800. As shown in FIG. 14, the wireless communication interface 1825 may include multiple RF circuitry 1827. For example, the multiple RF circuitry 1827 may be compatible with multiple antenna elements. Although FIG. 18 shows an example in which the wireless communication interface 1825 includes multiple BB processors 1826 and multiple RF circuitry 1827, the wireless communication interface 1825 may include a single BB processor 1826 or a single RF circuitry 1827.

In the eNB 1800 shown in FIG. 14, the communication function of the processing circuitry of the electronic device on the base station side in the secondary system described in <4. Example of an electronic device on a side of a base station in a secondary system> may be implemented by the wireless communication interface 1825. At least a part of the functions of the electronic device on the base station side in the secondary system for acquiring spectrum usage related information may be implemented by the controller 1821. For example, the controller 1821 may implement at least a part of the acquisition function of the electronic device on the base station side in the secondary system by executing the instructions stored in the memory 1822, which is not repeated here.

### Second Application Example

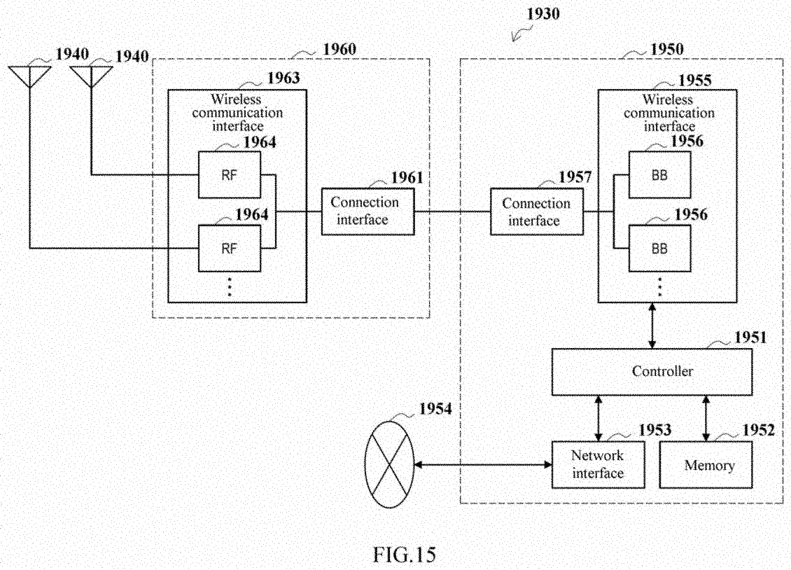

FIG. 15 is a block diagram illustrating a second example of a schematic configuration of an eNB to which the technology of the present disclosure may be applied. eNB 1930 includes one or more antennas 1940, a base station device 1950 and an RRH 1960. The RRH 1960 may be connected to each antenna 1940 via an RF cable. The base station device 1950 may be connected to the RRH 1960 via a high-speed line such as an optical fiber cable.

Each of the antennas 1940 includes a single or multiple antenna elements (such as multiple antenna elements included in a MIMO antenna) and is utilized by the RRH 1960 to transmit and receive wireless signals. As shown in FIG. 15, the eNB 1930 may include multiple antennas 1940. For example, the multiple antennas 1940 may be compatible with multiple frequency bands utilized by the eNB 1930. Although FIG. 15 shows an example in which the eNB 1930 includes the multiple antennas 1940, the eNB 1930 may also include a single antenna 1940.

The base station device 1950 includes a controller 1951, a memory 1952, a network interface 1953, a wireless communication interface 1955, and a connection interface 1957. The controller 1951, the memory 1952 and the network interface 1953 are the same as the controller 1821, the memory 1822 and the network interface 1823 described with reference to FIG. 15, respectively.

The wireless communication interface 1955 supports any cellular communication scheme, such as LTE and LTE-Advanced, and provides wireless communication via an RRH 1960 and the antenna 1940 to terminals located in a sector corresponding to the RRH 1960.

The wireless communication interface 1955 may generally include, for example, a BB processor 1956. The BB processor 1956 is the same as the BB processor 1826 described with reference to FIG. 14, except that the BB processor 1956 is connected to the RF circuitry 1964 of the RRH 1960 via the connection interface 1957. As shown in FIG. 15, the wireless communication interface 1955 may include multiple BB processors 1956. For example, the multiple BB processors 1956 may be compatible with multiple frequency bands utilized by the eNB 1930. Although FIG. 19 shows an example in which the wireless communication interface 1955 includes the multiple BB processors 1956, the wireless communication interface 1955 may also include a single BB processor 1956.

The connection interface 1957 is an interface for connecting the base station device 1950 (the wireless communication interface 1955) to the RRH 1960. The connection interface 1957 may also be a communication module for communication in the above-described high-speed line connecting the base station device 1950 (the wireless communication interface 1955) to the RRH 1960.

The RRH 1960 includes a connection interface 1961 and a wireless communication interface 1963.

The connection interface 1961 is an interface for connecting the RRH 1960 (the wireless communication interface 1963) to the base station device 1950. The connection interface 1961 may also be a communication module for communication in the above-mentioned high-speed line.

The wireless communication interface 1963 transmits and receives wireless signals via the antenna 1940. The wireless communication interface 1963 may generally include RF circuitry 1964, for example. The RF circuitry 1964 may include, for example, a mixer, a filter, and an amplifier, and transmit and receive wireless signals via the antenna 1940. As shown in FIG. 15, the wireless communication interface 1963 may include multiple RF circuitry 1964. For example, the multiple RF circuitry 1964 may support multiple antenna elements.

Although FIG. 15 shows an example in which the wireless communication interface 1963 includes the multiple RF circuitry 1964, the wireless communication interface 1963 may include a single RF circuitry 1964.

In the eNB 1930 shown in FIG. 15, the communication function of the processing circuitry of the electronic device on the base station side in the secondary system described in <4. Example of an electronic device on a side of a base station in a secondary system> may be implemented by the wireless communication interface 1963. At least a part of the functions of acquiring spectrum usage related information of the electronic device on the base station side in the secondary system may be implemented by the controller 1951. For example, the controller 1951 may implement at least a part of the acquisition function of the electronic device on the base station side in the secondary system by executing the instructions stored in the memory 1952, which is not repeated here.

The basic principles of the present disclosure have been described above with reference to specific embodiments. However, it should be pointed out that those skilled in the art should understand that all or any steps or components of the method and device of the present disclosure may be implemented in any computing device (including a processor, a storage medium and the like) or a network of computing devices in the form of hardware, firmware, software, or a combination thereof. This can be achieved by those skilled in the art using their basic circuitry design knowledge or basic programming skills after reading the description of the present disclosure.

Furthermore, a program product storing machine-readable instruction codes is further provided according to the present disclosure. When the instruction codes are read and executed by a machine, the above method according to the embodiment of the present disclosure is implemented.

Correspondingly, a storage medium for carrying the program product storing the machine-readable instruction codes is also included in the present disclosure. The storage medium includes, but is not limited to, a floppy disk, an optical disk, a magneto-optical disk, a memory card, a memory stick, and the like.

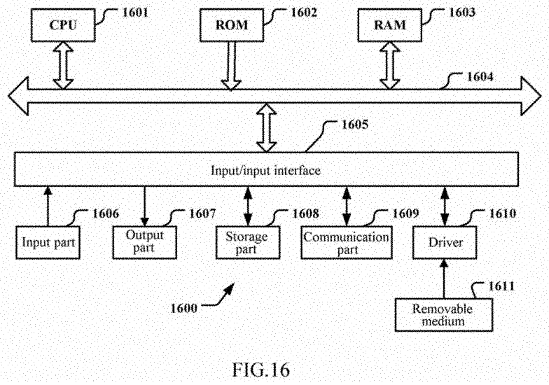

In the case where the present disclosure is implemented by software or firmware, a program constituting the software is installed from a storage medium or a network to a computer having a dedicated hardware structure (e.g., a general-purpose computer 1600 shown in FIG. 16). The computer executes various functions and the like when installed with various programs.

In FIG. 16, a central processing unit (CPU) 1601 performs various processing according to a program stored in a read only memory (ROM) 1602 or a program loaded from a storage part 1608 to a random-access memory (RAM) 1603. In the RAM 1603, data required when the CPU 1601 performs various processing and the like is also stored as necessary. The CPU 1601, the ROM 1602 and the RAM 1603 are connected to each other via a bus 1604. An input/output interface 1605 is also connected to the bus 1604.

The following components are connected to the input/output interface 1605: an input part 1606 (including a keyboard, mouse and the like), an output part 1607 (including a display such as a cathode ray tube (CRT) and a liquid crystal display (LCD), as well as a speaker and the like), a storage part 1608 (including a hard disk and the like), a communication part 1609 (including a network interface card such as a LAN card and a modem). The communication part 1609 performs communication processing via a network such as the Internet. A driver 1610 may also be connected to the input/output interface 1605 as necessary. A removable medium 1611 such as a magnetic disk, an optical disk, a magneto-optical disk, or a semiconductor memory is mounted on the driver 1610 as necessary, so that a computer program read therefrom is installed into the storage part 1608 as necessary.

In the case where the series of processing is implemented by software, a program constituting the software is installed from a network such as the Internet or a storage medium such as the removable medium 1611.

It should be understood by those skilled in the art that the storage medium is not limited to the removable medium 1611 shown in FIG. 16 in which the program is stored and distributed separately from the device to provide the program to the user. Examples of the removable medium 1611 include a magnetic disk (including a floppy disk (registered trademark)), an optical disk (including a compact disk read only memory (CD-ROM) and a digital versatile disk (DVD)), a magneto-optical disk (including a minidisc (MD) (registered trademark)) and a semiconductor memory. Alternatively, the storage medium may be the ROM 1602, a hard disk included in the storage part 1608 or the like, in which programs are stored and distributed to user together with the device that includes the storage medium.

Preferred embodiments of the present disclosure have been described above with reference to the accompanying drawings. However, the present disclosure is not limited to the above examples. Those skilled in the art may male various changes and modifications within the scope of the appended claims. It should be understood that such changes and modifications naturally fall within the technical scope of the present disclosure.

For example, in the functional block diagram shown in the drawings, the units shown in dotted boxes all indicate that the functional units are optional in the corresponding device. Further, the various optional functional units may be combined in an appropriate manner to achieve the desired functions.

For example, multiple functions included in one unit in the above embodiments may be implemented by separate devices. Alternatively, multiple functions implemented by multiple units in the above embodiments may be implemented by separate devices. In addition, one of the above functions may be implemented by multiple units. Needless to say, such a configuration is included in the technical scope of the present disclosure.

In this specification, the steps described in the flowchart include not only processing performed in time series in the stated order, but also processing performed in parallel or individually rather than necessarily in time series. Furthermore, even in the steps processed in time series, needless to say, the order may be appropriately changed.

Furthermore, the present disclosure may have configurations as described below.

(1) An electronic device, including:

processing circuitry configured to:

receive spectrum usage statistical information from at least one sub-spectrum management device, the spectrum usage statistical information including:
spectrum usage related information of a secondary system managed by the sub-spectrum management device, and
interference related information of the secondary system managed by the sub-spectrum management device; and

generate, based on the spectrum usage statistical information from the at least one sub-spectrum management device, spectrum usage guidance information for a secondary system managed by each sub-spectrum management device, where the at least one sub-spectrum management device is in an offline state.

(2) The electronic device according to (1), where the offline state refers to a state of not communicating with the electronic device in real time.

(3) The electronic device according to (1), where the interference related information of the secondary system indicates interference suffered by the secondary system that is determined through measurement.

(4) The electronic device according to (1), where the spectrum usage related information of the secondary system indicates an area, a frequency band and a time of spectrum usage of the secondary system, and the interference related information of the secondary system indicates an area, a frequency band and a time of interference suffered by the secondary system, where the spectrum usage related information of the secondary system includes a geographic location, a coverage, as well as a time and a frequency band of spectrum usage of a base station of the secondary system.

(5) The electronic device according to (4), where the processing circuitry is further configured to:

exclude, based on spectrum usage statistical information from multiple sub-spectrum management devices, from interference suffered by a secondary system managed by each sub-spectrum management device, a portion whose area, frequency band and time overlap an area, a frequency band and a time of spectrum usage of a secondary system managed by another sub-spectrum management device, and determine a result of the excluding as interference from unknown sources suffered by the secondary system managed by each sub-spectrum management device; and

accumulate, with respect to all the determined interference from unknown sources, times of respective interference from unknown sources in terms of an area and a frequency band, to determine interference integration information associated with the area and the frequency band.

(6) The electronic device according to (5), where the processing circuitry is further configured to:

accumulate, based on the spectrum usage statistical information from the multiple sub-spectrum management devices, for each sub-spectrum management device, a time of spectrum usage of a secondary system managed by that sub-spectrum management device in terms of an area, to determine spectrum usage integration information associated with the area.

(7) The electronic device according to (5) or (6), where the processing circuitry is further configured to:

generate, based on the determined integration information, frequency band recommendation information associated with an area for a secondary system managed by each sub-spectrum management device, as the spectrum usage guidance information.

(8) The electronic device according to (7), where the frequency band recommendation information includes recommended frequency bands arranged in order of priority.

(9) An electronic device, including:

processing circuitry configured to:

acquire spectrum usage statistical information, the spectrum usage statistical information including:
spectrum usage related information of a secondary system managed by said electronic device, and
interference related information of the secondary system managed by said electronic device;

send the acquired spectrum usage statistical information to a central spectrum device for the central spectrum device to generate, based on spectrum usage statistical information from at least one of the electronic device in an offline state, spectrum usage guidance information for a secondary system managed by each said electronic device.

(10) The electronic device according to (9), where the offline state refers to a state of not communicating with the central spectrum device in real time.

(11) The electronic device according to (9), where the interference related information of the secondary system indicates interference suffered by the secondary system that is determined through measurement.

(12) The electronic device according to (9), where the spectrum usage related information of the secondary system indicates an area, a frequency band and a time of spectrum usage of the secondary system, and the interference related information of the secondary system indicates an area, a frequency band and a time of interference suffered by the secondary system, where the spectrum usage related information of the secondary system includes a geographic location, a coverage, as well as a time and a frequency band of spectrum usage of a base station of the secondary system.

(13) The electronic device according to (9), where the processing circuitry is configured to periodically or aperiodically send the acquired spectrum usage statistical information to the central spectrum device.

(14) The electronic device according to (9), where the processing circuitry is further configured to determine spectrum usage of the secondary system managed by the electronic device with reference to the spectrum usage guidance information generated by the central spectrum device.

(15) An electronic device, including:

processing circuitry, configured to:

acquire spectrum usage related information of a secondary system in which the electronic device is located; and

send the acquired spectrum usage related information to a sub-spectrum management device that manages the secondary system, for the sub-spectrum management device to send the spectrum usage related information and interference related information of the secondary system to a central spectrum device as spectrum usage statistical information, where the central spectrum device is configured to generate, based on spectrum usage statistical information from at least one of the sub-spectrum management device in an offline state, spectrum usage guidance information for a secondary system managed by each sub-spectrum management device.

(16) An electronic device, including:

processing circuitry configured to:

acquire spectrum usage statistical information of a secondary system managed by the electronic device, the spectrum usage statistical information including:
spectrum usage related information of the secondary system managed by the electronic device, and
interference related information of the secondary system managed by the electronic device;

receive spectrum usage statistical information from another electronic device, where at least one of the another electronic device is in an offline state; and

generate, based on the acquired spectrum usage statistical information and the received spectrum usage statistical information, spectrum usage guidance information for the secondary system managed by the electronic device.

(17) The electronic device according to (16), where the offline state is a state of no real-time communication between electronic devices.

(18) The electronic device according to (16), where the interference related information of the secondary system indicates interference suffered by the secondary system that is determined through measurement.

(19) The electronic device according to (16), where the spectrum usage related information of the secondary system indicates an area, a frequency band and a time of spectrum usage of the secondary system, and the interference related information of the secondary system indicates an area, a frequency band and a time of interference suffered by the secondary system, where the spectrum usage related information of the secondary system includes a geographic location, a coverage, as well as a time and a frequency band of spectrum usage of a base station of the secondary system.

(20) The electronic device according to (19), where the processing circuitry is further configured to:

exclude, based on the acquired spectrum usage statistical information and the received spectrum usage statistical information, from interference suffered by a secondary system managed by each of the electronic device, a portion whose area, frequency band and time overlap an area, a frequency band and a time of spectrum usage of a secondary system managed by another electronic device, and determine a result of the excluding as interference from unknown sources suffered by the secondary system managed by each electronic device; and

accumulate, with respect to all the determined interference from unknown sources, times of respective interference from unknown sources in terms of an area and a frequency band, to determine interference integration information associated with the area and the frequency band.

(21) The electronic device according to (20), where the processing circuitry is further configured to:

accumulate, based on the acquired spectrum usage statistical information and the received spectrum usage statistical information, for each electronic device, a time of spectrum usage of a secondary system managed by that electronic device in terms of an area, to determine spectrum usage integration information associated with the area.

(22) The electronic device according to (20) or (21), where the processing circuitry is further configured to:

generate, based on the determined integration information, frequency band recommendation information associated with an area for a secondary system managed by the electronic device, as the spectrum usage guidance information.

(23) The electronic device according to (22), where the frequency band recommendation information includes recommended frequency bands arranged in order of priority.

(24) The electronic device according to (16), where the processing circuitry is configured to periodically or aperiodically receive spectrum usage statistical information from the another electronic device.

(25) The electronic device according to (16), where the processing circuitry is further configured to periodically or aperiodically send the acquired spectrum usage statistical information of the secondary system managed by the electronic device to the another electronic device.

(26) The electronic device according to (16), where the processing circuitry is further configured to exchange synchronization period information with the another electronic device.

(27) The electronic device according to (16), where the processing circuitry is further configured to determine spectrum usage of a secondary system managed by the electronic device with reference to the generated spectrum usage guidance information.

(28) An electronic device, including:

processing circuitry configured to:

acquire spectrum usage related information of a secondary system in which the electronic device is located; and

send the acquired spectrum usage related information to a spectrum management device that manages the secondary system, for the spectrum management device to generate spectrum usage guidance information for the secondary system based on spectrum usage statistical information including the spectrum usage related information and interference related information of the secondary system, as well as spectrum usage statistical information from another spectrum management device, where at least one of the another spectrum management device is in an offline state.

(29) A method in an electronic device, the method including:

receiving spectrum usage statistical information from at least one sub-spectrum management device, the spectrum usage statistical information including:
spectrum usage related information of a secondary system managed by the sub-spectrum management device, and
interference related information of the secondary system managed by the sub-spectrum management device; and

generating, based on the spectrum usage statistical information from the at least one sub-spectrum management device, spectrum usage guidance information for a secondary system managed by each sub-spectrum management device, where the at least one sub-spectrum management device is in an offline state.

(30) A method in an electronic device, the method including:

acquiring spectrum usage statistical information, the spectrum usage statistical information including:
spectrum usage related information of a secondary system managed by the electronic device, and
interference related information of the secondary system managed by said electronic device;

sending the acquired spectrum usage statistical information to a central spectrum device for the central spectrum device to generate, based on spectrum usage statistical information from at least one of the electronic device in an offline state, spectrum usage guidance information for a secondary system managed by each said electronic device.

(31) A method in an electronic device, the method including:

acquiring spectrum usage statistical information of a secondary system managed by the electronic device, the spectrum usage statistical information including:
spectrum usage related information of the secondary system managed by the electronic device, and
interference related information of the secondary system managed by the electronic device;

receiving spectrum usage statistical information from another electronic device, where at least one of the another electronic device is in an offline state; and

generating, based on the acquired spectrum usage statistical information and the received spectrum usage statistical information, spectrum usage guidance information for the secondary system managed by the electronic device.

(32) A non-transitory computer readable storage medium storing a program which, when executed by a processor, causes the processor to perform the method according to any one of (29) to (31).

Although the embodiments of the present disclosure have been described in detail above with reference to the drawings. However, it should be understood that the above-described embodiments are only for illustrating the present disclosure rather than limiting the present disclosure. Various modifications and variations of the above-described embodiments may be made by those skilled in the art without departing from the spirit and scope of the present disclosure. Accordingly, the scope of the present disclosure is to be limited by only the appended claims and their equivalents.

1. An electronic device, comprising:
processing circuitry configured to:
receive spectrum usage statistical information from at least one sub-spectrum management device, the spectrum usage statistical information including:
spectrum usage related information of a secondary system managed by the sub-spectrum management device, and
interference related information of the secondary system managed by the sub-spectrum management device; and
generate, based on the spectrum usage statistical information from the at least one sub-spectrum management device, spectrum usage guidance information for a secondary system managed by each sub-spectrum management device, wherein the at least one sub-spectrum management device is in an offline state.

2. The electronic device according to claim 1, wherein
the offline state refers to a state of not communicating with the electronic device in real time, and/or
the interference related information of the secondary system indicates interference suffered by the secondary system that is determined through measurement.

3. (canceled)

4. The electronic device according to claim 1, wherein the spectrum usage related information of the secondary system indicates an area, a frequency band and a time of spectrum usage of the secondary system, and the interference related information of the secondary system indicates an area, a frequency band and a time of interference suffered by the secondary system, wherein the spectrum usage related information of the secondary system includes a geographic location, a coverage, as well as a time and a frequency band of spectrum usage of a base station of the secondary system.

5. The electronic device according to claim 4, wherein the processing circuitry is further configured to:
exclude, based on spectrum usage statistical information from a plurality of sub-spectrum management devices, from interference suffered by a secondary system managed by each sub-spectrum management device, a portion whose area, frequency band and time overlap an area, a frequency band and a time of spectrum usage of a secondary system managed by another sub-spectrum management device, and determine a result of the excluding as interference from unknown sources suffered by the secondary system managed by each sub-spectrum management device; and
accumulate, with respect to all the determined interference from unknown sources, times of respective interference from unknown sources in terms of an area and a frequency band, to determine interference integration information associated with the area and the frequency band.

6. The electronic device according to claim 5, wherein the processing circuitry is further configured to:
accumulate, based on the spectrum usage statistical information from the plurality of sub-spectrum management devices, for each sub-spectrum management device, a time of spectrum usage of a secondary system managed by that sub-spectrum management device in terms of an area, to determine spectrum usage integration information associated with the area.

7. The electronic device according to claim 5, wherein the processing circuitry is further configured to:
generate, based on the determined integration information, frequency band recommendation information associated with an area for a secondary system managed by each sub-spectrum management device, as the spectrum usage guidance information.

8. The electronic device according to claim 7, wherein the frequency band recommendation information includes recommended frequency bands arranged in order of priority.

9. An electronic device, comprising:
processing circuitry configured to:
acquire spectrum usage statistical information, the spectrum usage statistical information including:
spectrum usage related information of a secondary system managed by said electronic device, and
interference related information of the secondary system managed by said electronic device;
send the acquired spectrum usage statistical information to a central spectrum device, for the central spectrum device to generate, based on spectrum usage statistical information from at least one of the electronic device in an offline state, spectrum usage guidance information for a secondary system managed by each said electronic device.

10. The electronic device according to claim 9, wherein
the offline state refers to a state of not communicating with the central spectrum device in real time, and/or
the interference related information of the secondary system indicates interference suffered by the secondary system that is determined through measurement.

11. (canceled)

12. The electronic device according to claim 9, wherein the spectrum usage related information of the secondary system indicates an area, a frequency band and a time of spectrum usage of the secondary system, and the interference related information of the secondary system indicates an area, a frequency band and a time of interference suffered by the secondary system, wherein the spectrum usage related information of the secondary system includes a geographic location, a coverage, as well as a time and a frequency band of spectrum usage of a base station of the secondary system.

13. The electronic device according to claim 9, wherein the processing circuitry is configured to periodically or aperiodically send the acquired spectrum usage statistical information to the central spectrum device.

14. The electronic device according to claim 9, wherein the processing circuitry is further configured to determine spectrum usage of the secondary system managed by the electronic device with reference to the spectrum usage guidance information generated by the central spectrum device.

15. (canceled)

16. An electronic device, comprising:
processing circuitry configured to:
acquire spectrum usage statistical information of a secondary system managed by the electronic device, the spectrum usage statistical information comprising:
spectrum usage related information of the secondary system managed by the electronic device, and
interference related information of the secondary system managed by the electronic device;
receive spectrum usage statistical information from another electronic device, wherein at least one of the another electronic device is in an offline state; and
generate, based on the acquired spectrum usage statistical information and the received spectrum usage statistical information, spectrum usage guidance information for the secondary system managed by the electronic device.

17. The electronic device according to claim 16, wherein
the offline state is a state of no real-time communication between electronic devices, and/or
the interference related information of the secondary system indicates interference suffered by the secondary system that is determined through measurement.

18. (canceled)

19. The electronic device according to claim 16, wherein the spectrum usage related information of the secondary system indicates an area, a frequency band and a time of spectrum usage of the secondary system, and the interference related information of the secondary system indicates an area, a frequency band and a time of interference suffered by the secondary system, wherein the spectrum usage related information of the secondary system includes a geographic location, a coverage, as well as a time and a frequency band of spectrum usage of a base station of the secondary system.

20. The electronic device according to claim 19, wherein the processing circuitry is further configured to:
exclude, based on the acquired spectrum usage statistical information and the received spectrum usage statistical information, from interference suffered by a secondary system managed by each of the electronic device, a portion whose area, frequency band and time overlap an area, a frequency band and a time of spectrum usage of a secondary system managed by another electronic device, and determine a result of the excluding as interference from unknown sources suffered by the secondary system managed by each electronic device; and
accumulate, with respect to all the determined interference from unknown sources, times of respective interference from unknown sources in terms of an area and a frequency band, to determine interference integration information associated with the area and the frequency band.

21. The electronic device according to claim 20, wherein the processing circuitry is further configured to:
accumulate, based on the acquired spectrum usage statistical information and the received spectrum usage statistical information, for each electronic device, a time of spectrum usage of a secondary system managed by that electronic device in terms of an area, to determine spectrum usage integration information associated with the area.

22. The electronic device according to claim 20, wherein the processing circuitry is further configured to:
generate, based on the determined integration information, frequency band recommendation information associated with an area for a secondary system managed by the electronic device, as the spectrum usage guidance information.

23. The electronic device according to claim 22, wherein the frequency band recommendation information includes recommended frequency bands arranged in order of priority.

24. The electronic device according to claim 16, wherein the processing circuitry is configured to:
periodically or aperiodically receive spectrum usage statistical information from the another electronic device,
periodically or aperiodically send the acquired spectrum usage statistical information of the secondary system managed by the electronic device to the another electronic device,
exchange synchronization period information with the another electronic device, and/or
determine spectrum usage of a secondary system managed by the electronic device with reference to the generated spectrum usage guidance information.

25.-32. (canceled)
